(19) United States
(12) Patent Application Publication
(10) Pub. No.: US 2015/0156266 A1
(43) Pub. Date: Jun. 4, 2015

(54) DISCOVERING CLOUD-BASED SERVICES FOR IOT DEVICES IN AN IOT NETWORK ASSOCIATED WITH A USER

(71) Applicant: QUALCOMM Incorporated, San Diego, CA (US)

(72) Inventor: Binita GUPTA, San Diego, CA (US)

(21) Appl. No.: 14/550,595

(22) Filed: Nov. 21, 2014

Related U.S. Application Data
(60) Provisional application No. 61/910,199, filed on Nov. 29, 2013.

(51) Int. Cl. H04L 29/08

(52) U.S. Cl. CPC H04L 67/16; H04L 67/12

(57) ABSTRACT

The disclosure relates to discovering and offering cloud-based services for Internet of Things (IoT) devices in an IoT network. In particular, an IoT gateway or other suitable device can discover information (e.g., device classes) about the IoT devices in the IoT network, discover cloud-based services tagged with the discovered information about the IoT devices, and offer the discovered cloud-based services in the IoT network. Accordingly, in response to receiving a request to invoke a discovered cloud-based service from an IoT device and/or a user associated with the IoT network, the IoT gateway may connect to the appropriate IoT devices to fetch any required data associated with the requested cloud-based services, pass the fetched data to publishers or providers associated with the requested cloud-based services, and return a result from the invoked cloud-based services to the IoT devices in the IoT network.

### CROSS-REFERENCE TO RELATED APPLICATIONS

The present application for patent claims the benefit of Provisional Patent Application No. 61/910,199 entitled “MECHANISM TO DISCOVER CLOUD BASED SERVICES FOR IOT DEVICES IN A PROXIMAL NETWORK ASSOCIATED WITH A USER,” filed Nov. 29, 2013, and assigned to the assignee hereof and hereby expressly incorporated herein by reference in its entirety.

### TECHNICAL FIELD

Various embodiments described herein generally relate to mechanisms that may be used to discover cloud-based services for various Internet of Things (IoT) devices in an IoT network associated with a user.

### BACKGROUND

The Internet is a global system of interconnected computers and computer networks that use a standard Internet protocol suite (e.g., the Transmission Control Protocol (TCP) and Internet Protocol (IP)) to communicate with each other. The Internet of Things (IoT) is based on the idea that everyday objects, not just computers and computer networks, can be readable, recognizable, locatable, addressable, and controllable via an IoT communications network (e.g., an ad-hoc system or the Internet).

A number of market trends are driving development of IoT devices. For example, increasing energy costs are driving governments' strategic investments in smart grids and support for future consumption, such as for electric vehicles and public charging stations. Increasing health care costs and aging populations are driving development for remote/connected health care and fitness services. A technological revolution in the home is driving development for new “smart” services, including consolidation by service providers marketing ‘N’ play (e.g., data, voice, video, security, energy management, etc.) and expanding home networks. Buildings are getting smarter and more convenient as a means to reduce operational costs for enterprise facilities.

There are a number of key applications for the IoT. For example, in the area of smart grids and energy management, utility companies can optimize delivery of energy to homes and businesses while customers can better manage energy usage. In the area of home and building automation, smart homes and buildings can have centralized control over virtually any device or system in the home or office, from appliances to plug-in electric vehicle (PEV) security systems. In the field of asset tracking, enterprises, hospitals, factories, and other large organizations can accurately track the locations of high-value equipment, patients, vehicles, and so on. In the area of health and wellness, doctors can remotely monitor patients' health while people can track the progress of fitness routines.

Accordingly, in the near future, increasing development in IoT technologies will lead to numerous IoT devices surrounding a user at home, in vehicles, at work, and many other locations and personal spaces. As such, application providers may want to develop and host cloud-based services for certain IoT devices that may be used in these personal spaces (e.g., cloud-based services to provide recipe options based on refrigerator inventories, appliance monitoring and diagnostics, etc.). Accordingly, it may be desirable to have mechanisms that can dynamically discover cloud-based services for IoT devices in an IoT network or other personal space associated with a user and offer the dynamically discovered cloud-based services to the user.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method to discover cloud-based services for IoT devices in an IoT network associated with a user may comprise discovering information about the IoT devices in the IoT network associated with the user, wherein the discovered information includes at least one or more device classes associated with the IoT devices in the IoT network, discovering one or more cloud-based services tagged with the device classes associated with the IoT devices in the IoT network, and offering the discovered cloud-based services in the IoT network. As such, at least one of the discovered cloud-based services may be invoked in response to a request to invoke at least one of the cloud-based services offered in the IoT network from the user and/or an IoT device in the IoT network, wherein invoking the at least one cloud-based service may comprise connecting to one or more IoT devices in the IoT network to fetch any required data associated with the requested cloud-based service, passing the fetched data to a publisher or a provider associated with the requested cloud-based service, and returning a result from the invoked cloud-based service to the one or more IoT devices in the IoT network.

According to various aspects, an IoT gateway device may comprise one or more processors configured to discover information about one or more IoT devices in an IoT network, wherein the discovered information includes at least one or more device classes associated with the IoT devices in the IoT network, discover one or more cloud-based services tagged with the device classes associated with the IoT devices in the IoT network, and offer the discovered cloud-based services in the IoT network, and the IoT gateway device may further comprise a memory coupled to the one or more processors.

According to various aspects, an IoT gateway device may comprise means for discovering information about one or more IoT devices in an IoT network, wherein the discovered information includes at least one or more device classes associated with the IoT devices in the IoT network, means for discovering one or more cloud-based services tagged with the device classes associated with the one or more IoT devices in the IoT network, and means for offering the discovered cloud-based services in the IoT network.

According to various aspects, a computer-readable storage medium may have computer-executable instructions recorded thereon, wherein executing the computer-executable instructions on a gateway device in an IoT network may cause the gateway device to discover information about one or more IoT devices in the IoT network, wherein the discovered information includes at least one or more device classes associated with the one or more IoT devices in the IoT network, discover one or more cloud-based services tagged with the device classes associated with the one or more IoT devices in the IoT network, and offer the discovered cloud-based services in the IoT network.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIGS. 1A-1E illustrate exemplary high-level system architectures of wireless communications systems according to various aspects.

FIG. 2A illustrates an exemplary Internet of Things (IoT) device and FIG. 2B illustrates an exemplary passive IoT device, according to various aspects.

FIG. 3 illustrates a communication device that includes logic configured to perform functionality, according to various aspects.

FIG. 4 illustrates an exemplary server, according to various aspects.

FIG. 5 illustrates a wireless communication network that may support discoverable peer-to-peer (P2P) services, according to various aspects.

FIG. 6 illustrates an exemplary environment in which discoverable P2P services may be used to establish a proximity-based distributed bus over which various devices may communicate, according to various aspects.

FIG. 7 illustrates an exemplary signaling flow in which discoverable P2P services may be used to establish a proximity-based distributed bus over which various devices may communicate, according to various aspects.

FIG. 8A illustrates an exemplary proximity-based distributed bus that may be formed between two host devices, while FIG. 8B illustrates an exemplary proximity-based distributed bus in which one or more embedded devices may connect to a host device to connect to the proximity-based distributed bus, according to various aspects.

FIG. 9 illustrates an exemplary system that can discover cloud-based services for IoT devices in an IoT network associated with a user, in accordance with various aspects.

FIG. 10 illustrates an exemplary method to discover and offer cloud-based services in an IoT network associated with a user, in accordance with various aspects.

FIG. 11 illustrates an exemplary method to service requests to invoke cloud-based services offered in an IoT network, in accordance with various aspects.

FIG. 12 illustrates an exemplary communications device that may communicate over a proximity-based distributed bus using discoverable P2P services, in accordance with various aspects.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Further, many aspects are described in terms of sequences of actions to be performed by, for example, elements of a computing device. It will be recognized that various actions described herein can be performed by specific circuits (e.g., an application specific integrated circuit (ASIC)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the term “Internet of Things device” (or “IoT device”) may refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

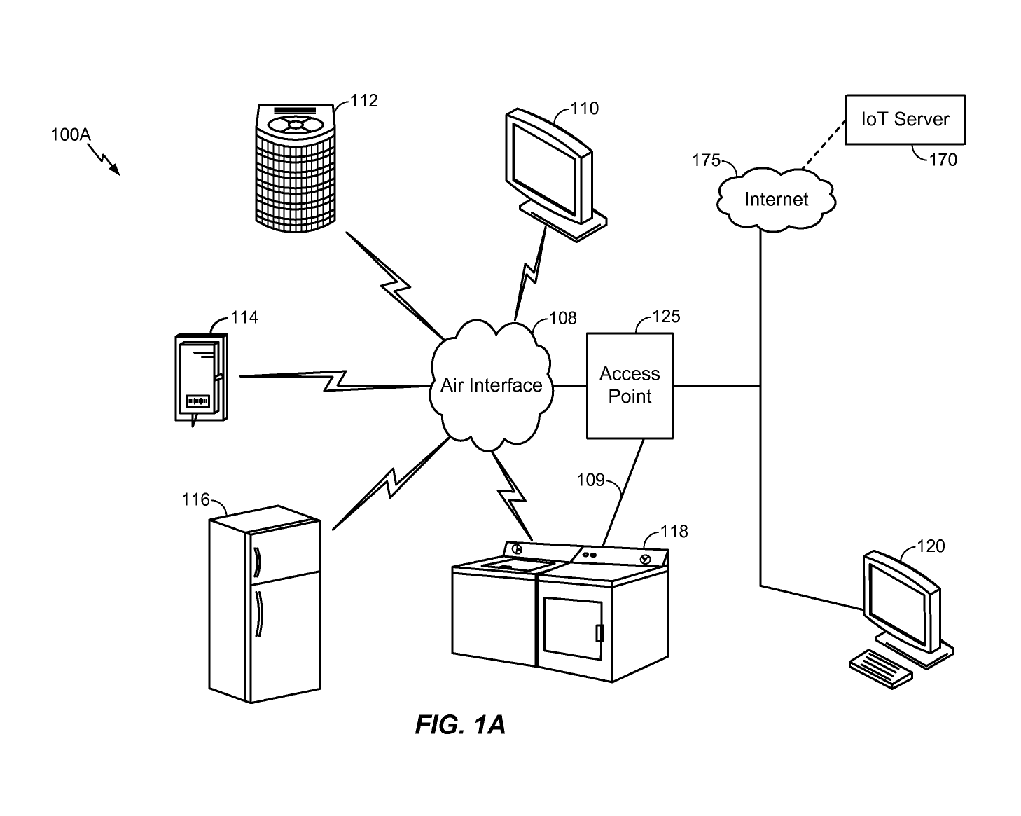

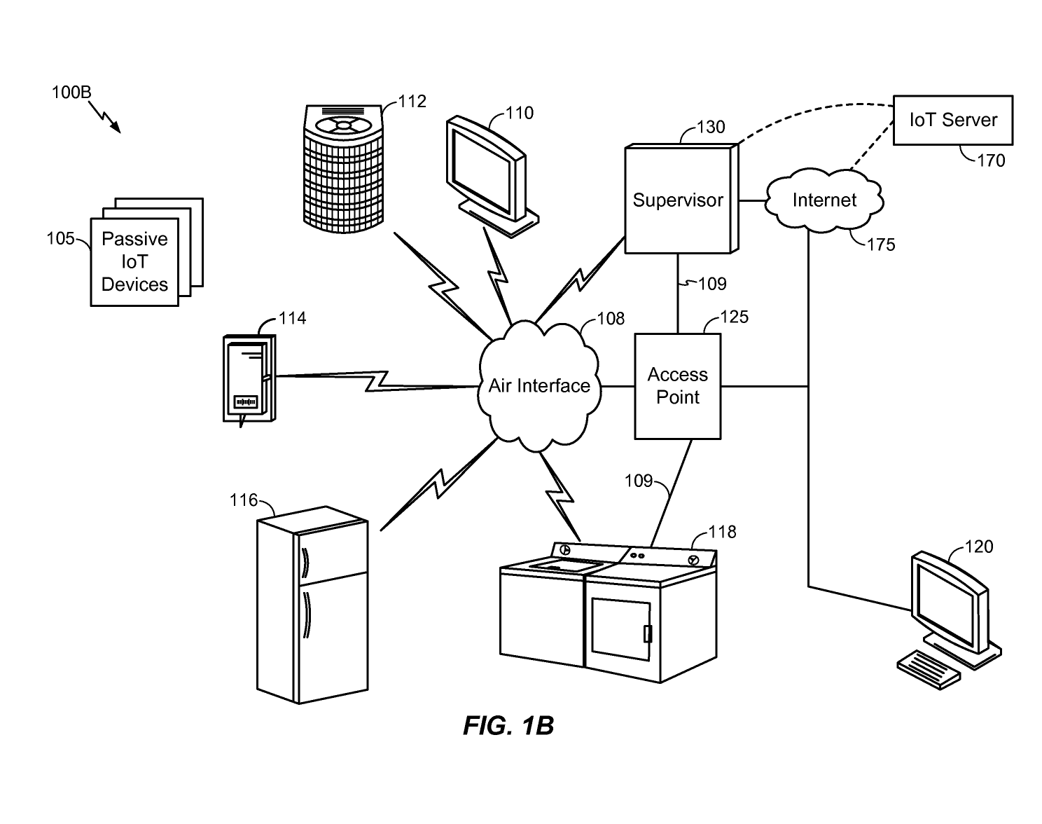

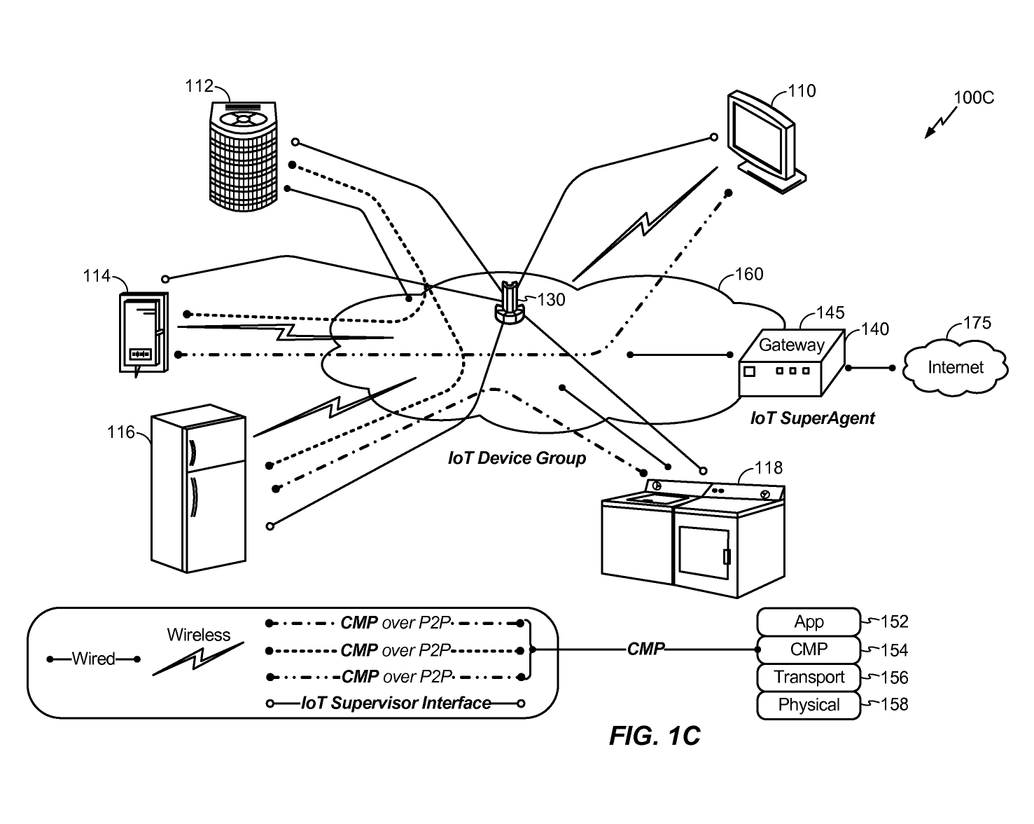

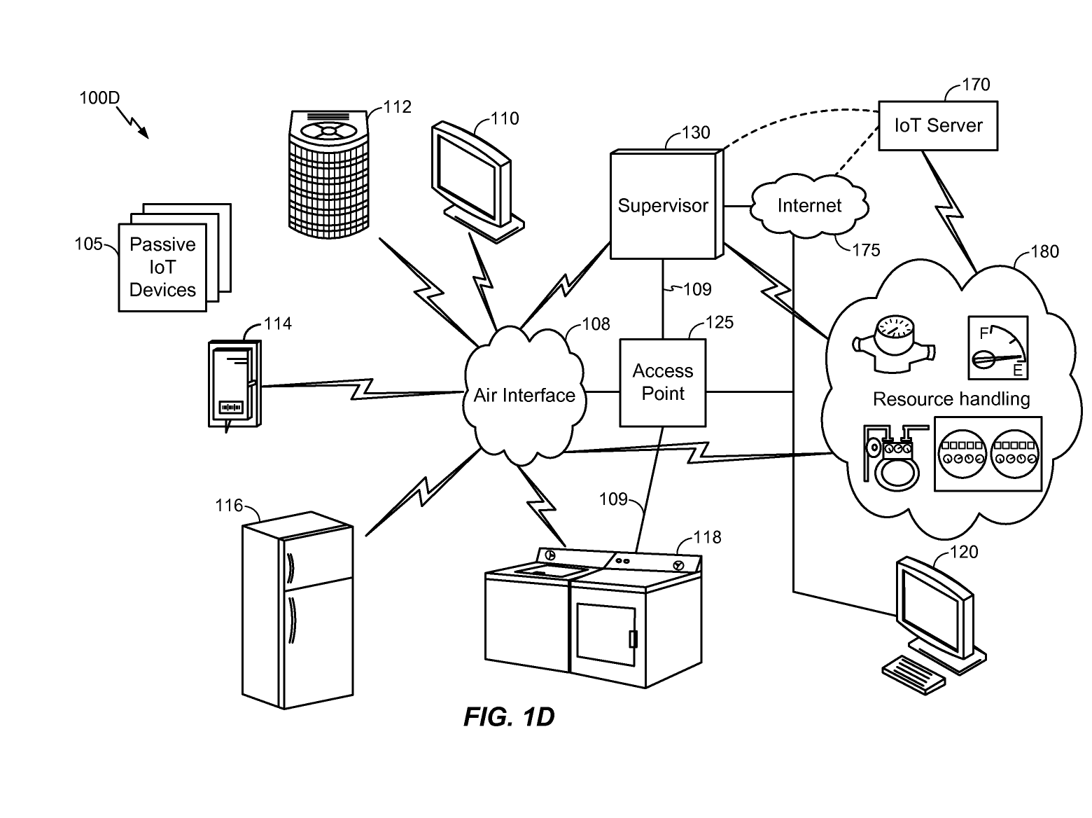

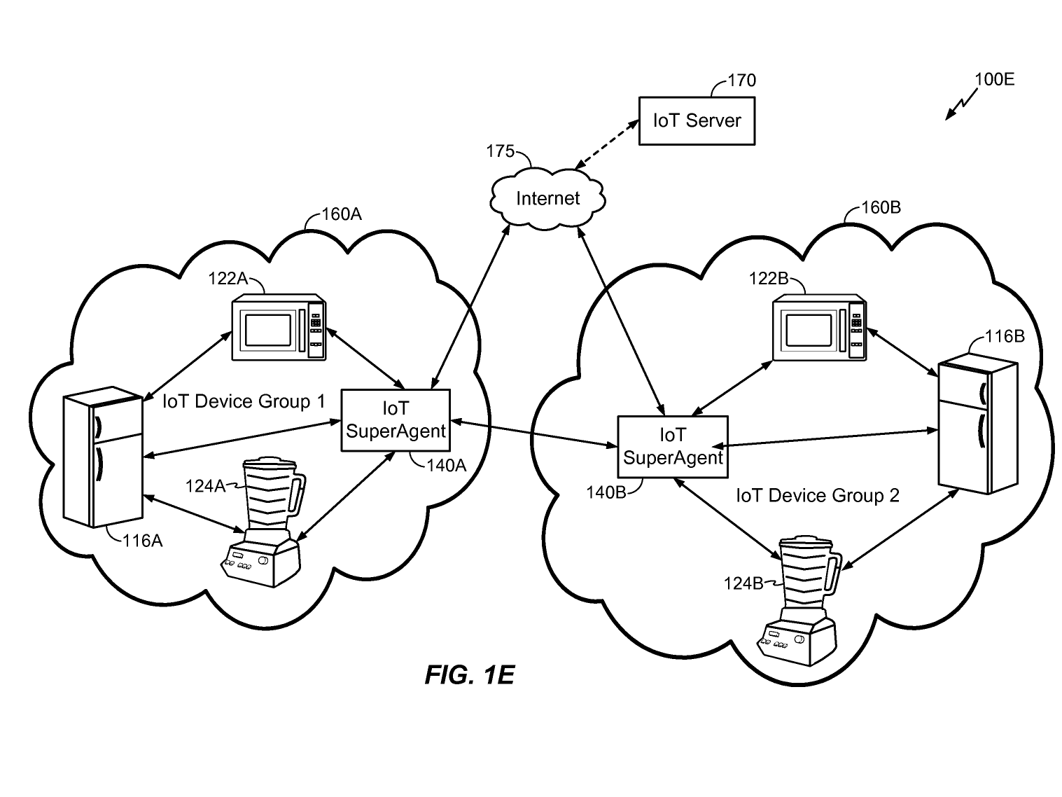

FIG. 1A illustrates a high-level system architecture of a wireless communications system 100A in accordance with various aspects. The wireless communications system 100A contains a plurality of IoT devices, which include a television 110, an outdoor air conditioning unit 112, a thermostat 114, a refrigerator 116, and a washer and dryer 118.

Referring to FIG. 1A, IoT devices 110-118 are configured to communicate with an access network (e.g., an access point 125) over a physical communications interface or layer, shown in FIG. 1A as air interface 108 and a direct wired connection 109. The air interface 108 can comply with a wireless Internet protocol (IP), such as IEEE 802.11. Although FIG. 1A illustrates IoT devices 110-118 communicating over the air interface 108 and IoT device 118 communicating over the direct wired connection 109, each IoT device may communicate over a wired or wireless connection, or both.

The Internet 175 includes a number of routing agents and processing agents (not shown in FIG. 1A for the sake of convenience). The Internet 175 is a global system of interconnected computers and computer networks that uses a standard Internet protocol suite (e.g., the Transmission Control Protocol (TCP) and IP) to communicate among disparate devices/networks. TCP/IP provides end-to-end connectivity specifying how data should be formatted, addressed, transmitted, routed and received at the destination.

In FIG. 1A, a computer 120, such as a desktop or personal computer (PC), is shown as connecting to the Internet 175 directly (e.g., over an Ethernet connection or Wi-Fi or 802.11-based network). The computer 120 may have a wired connection to the Internet 175, such as a direct connection to a modem or router, which, in an example, can correspond to the access point 125 itself (e.g., for a Wi-Fi router with both wired and wireless connectivity). Alternatively, rather than being connected to the access point 125 and the Internet 175 over a wired connection, the computer 120 may be connected to the access point 125 over air interface 108 or another wireless interface, and access the Internet 175 over the air interface 108. Although illustrated as a desktop computer, computer 120 may be a laptop computer, a tablet computer, a PDA, a smart phone, or the like. The computer 120 may be an IoT device and/or contain functionality to manage an IoT network/group, such as the network/group of IoT devices 110-118.

The access point 125 may be connected to the Internet 175 via, for example, an optical communication system, such as FiOS, a cable modem, a digital subscriber line (DSL) modem, or the like. The access point 125 may communicate with IoT devices 110-120 and the Internet 175 using the standard Internet protocols (e.g., TCP/IP).

Referring to FIG. 1A, an IoT server 170 is shown as connected to the Internet 175. The IoT server 170 can be implemented as a plurality of structurally separate servers, or alternately may correspond to a single server. In various embodiments, the IoT server 170 is optional (as indicated by the dotted line), and the group of IoT devices 110-120 may be a peer-to-peer (P2P) network. In such a case, the IoT devices 110-120 can communicate with each other directly over the air interface 108 and/or the direct wired connection 109. Alternatively, or additionally, some or all of IoT devices 110-120 may be configured with a communication interface independent of air interface 108 and direct wired connection 109. For example, if the air interface 108 corresponds to a Wi-Fi interface, one or more of the IoT devices 110-120 may have Bluetooth or NFC interfaces for communicating directly with each other or other Bluetooth or NFC-enabled devices.

In a peer-to-peer network, service discovery schemes can multicast the presence of nodes, their capabilities, and group membership. The peer-to-peer devices can establish associations and subsequent interactions based on this information.

In accordance with various aspects, FIG. 1B illustrates a high-level architecture of another wireless communications system 100B that contains a plurality of IoT devices. In general, the wireless communications system 100B shown in FIG. 1B may include various components that are the same and/or substantially similar to the wireless communications system 100A shown in FIG. 1A, which was described in greater detail above (e.g., various IoT devices, including a television 110, outdoor air conditioning unit 112, thermostat 114, refrigerator 116, and washer and dryer 118, that are configured to communicate with an access point 125 over an air interface 108 and/or a direct wired connection 109, a computer 120 that directly connects to the Internet 175 and/or connects to the Internet 175 through access point 125, and an IoT server 170 accessible via the Internet 175, etc.). As such, for brevity and ease of description, various details relating to certain components in the wireless communications system 100B shown in FIG. 1B may be omitted herein to the extent that the same or similar details have already been provided above in relation to the wireless communications system 100A illustrated in FIG. 1A.

Referring to FIG. 1B, the wireless communications system 100B may include a supervisor device 130, which may alternatively be referred to as an IoT manager 130 or IoT manager device 130. As such, where the following description uses the term “supervisor device” 130, those skilled in the art will appreciate that any references to an IoT manager, group owner, or similar terminology may refer to the supervisor device 130 or another physical or logical component that provides the same or substantially similar functionality.

In various embodiments, the supervisor device 130 may generally observe, monitor, control, or otherwise manage the various other components in the wireless communications system 100B. For example, the supervisor device 130 can communicate with an access network (e.g., access point 125) over air interface 108 and/or a direct wired connection 109 to monitor or manage attributes, activities, or other states associated with the various IoT devices 110-120 in the wireless communications system 100B. The supervisor device 130 may have a wired or wireless connection to the Internet 175 and optionally to the IoT server 170 (shown as a dotted line). The supervisor device 130 may obtain information from the Internet 175 and/or the IoT server 170 that can be used to further monitor or manage attributes, activities, or other states associated with the various IoT devices 110-120. The supervisor device 130 may be a standalone device or one of IoT devices 110-120, such as computer 120. The supervisor device 130 may be a physical device or a software application running on a physical device. The supervisor device 130 may include a user interface that can output information relating to the monitored attributes, activities, or other states associated with the IoT devices 110-120 and receive input information to control or otherwise manage the attributes, activities, or other states associated therewith. Accordingly, the supervisor device 130 may generally include various components and support various wired and wireless communication interfaces to observe, monitor, control, or otherwise manage the various components in the wireless communications system 100B.

The wireless communications system 100B shown in FIG. 1B may include one or more passive IoT devices 105 (in contrast to the active IoT devices 110-120) that can be coupled to or otherwise made part of the wireless communications system 100B. In general, the passive IoT devices 105 may include barcoded devices, Bluetooth devices, radio frequency (RF) devices, RFID tagged devices, infrared (IR) devices, NFC tagged devices, or any other suitable device that can provide its identifier and attributes to another device when queried over a short range interface. Active IoT devices may detect, store, communicate, act on, and/or the like, changes in attributes of passive IoT devices.

For example, passive IoT devices 105 may include a coffee cup and a container of orange juice that each have an RFID tag or barcode. A cabinet IoT device and the refrigerator IoT device 116 may each have an appropriate scanner or reader that can read the RFID tag or barcode to detect when the coffee cup and/or the container of orange juice passive IoT devices 105 have been added or removed. In response to the cabinet IoT device detecting the removal of the coffee cup passive IoT device 105 and the refrigerator IoT device 116 detecting the removal of the container of orange juice passive IoT device, the supervisor device 130 may receive one or more signals that relate to the activities detected at the cabinet IoT device and the refrigerator IoT device 116. The supervisor device 130 may then infer that a user is drinking orange juice from the coffee cup and/or likes to drink orange juice from a coffee cup.

Although the foregoing describes the passive IoT devices 105 as having some form of RFID tag or barcode communication interface, the passive IoT devices 105 may include one or more devices or other physical objects that do not have such communication capabilities. For example, certain IoT devices may have appropriate scanner or reader mechanisms that can detect shapes, sizes, colors, and/or other observable features associated with the passive IoT devices 105 to identify the passive IoT devices 105. In this manner, any suitable physical object may communicate its identity and attributes and become part of the wireless communication system 100B and be observed, monitored, controlled, or otherwise managed with the supervisor device 130. Further, passive IoT devices 105 may be coupled to or otherwise made part of the wireless communications system 100A in FIG. 1A and observed, monitored, controlled, or otherwise managed in a substantially similar manner.

In accordance with various aspects, FIG. 1C illustrates a high-level architecture of another wireless communications system 100C that contains a plurality of IoT devices. In general, the wireless communications system 100C shown in FIG. 1C may include various components that are the same and/or substantially similar to the wireless communications systems 100A and 100B shown in FIGS. 1A and 1B, respectively, which were described in greater detail above. As such, for brevity and ease of description, various details relating to certain components in the wireless communications system 100C shown in FIG. 1C may be omitted herein to the extent that the same or similar details have already been provided above in relation to the wireless communications systems 100A and 100B illustrated in FIGS. 1A and 1B, respectively.

The communications system 100C shown in FIG. 1C illustrates exemplary peer-to-peer communications between the IoT devices 110-118 and the supervisor device 130. As shown in FIG. 1C, the supervisor device 130 communicates with each of the IoT devices 110-118 over an IoT supervisor interface. Further, IoT devices 110 and 114, IoT devices 112, 114, and 116, and IoT devices 116 and 118, communicate directly with each other.

The IoT devices 110-118 make up an IoT group 160. An IoT device group 160 is a group of locally connected IoT devices, such as the IoT devices connected to a user's home network. Although not shown, multiple IoT device groups may be connected to and/or communicate with each other via an IoT SuperAgent 140 connected to the Internet 175. At a high level, the supervisor device 130 manages intra-group communications, while the IoT SuperAgent 140 can manage inter-group communications. Although shown as separate devices, the supervisor device 130 and the IoT SuperAgent 140 may be, or reside on, the same device (e.g., a standalone device or an IoT device, such as computer 120 in FIG. 1A). Alternatively, the IoT SuperAgent 140 may correspond to or include the functionality of the access point 125. As yet another alternative, the IoT SuperAgent 140 may correspond to or include the functionality of an IoT server, such as IoT server 170. The IoT SuperAgent 140 may encapsulate gateway functionality 145.

Each IoT device 110-118 can treat the supervisor device 130 as a peer and transmit attribute/schema updates to the supervisor device 130. When an IoT device needs to communicate with another IoT device, it can request the pointer to that IoT device from the supervisor device 130 and then communicate with the target IoT device as a peer. The IoT devices 110-118 communicate with each other over a peer-to-peer communication network using a common messaging protocol (CMP). As long as two IoT devices are CMP-enabled and connected over a common communication transport, they can communicate with each other. In the protocol stack, the CMP layer 154 is below the application layer 152 and above the transport layer 156 and the physical layer 158.

In accordance with various aspects, FIG. 1D illustrates a high-level architecture of another wireless communications system 100D that contains a plurality of IoT devices. In general, the wireless communications system 100D shown in FIG. 1D may include various components that are the same and/or substantially similar to the wireless communications systems 100A-100C shown in FIGS. 1A-1C, respectively, which were described in greater detail above. As such, for brevity and ease of description, various details relating to certain components in the wireless communications system 100D shown in FIG. 1D may be omitted herein to the extent that the same or similar details have already been provided above in relation to the wireless communications systems 100A-100C illustrated in FIGS. 1A-1C, respectively.

The Internet 175 is a “resource” that can be regulated using the concept of the IoT. However, the Internet 175 is just one example of a resource that is regulated, and any resource could be regulated using the concept of the IoT. Other resources that can be regulated include, but are not limited to, electricity, gas, storage, security, and the like. An IoT device may be connected to the resource and thereby regulate it, or the resource could be regulated over the Internet 175. FIG. 1D illustrates several resources 180, such as natural gas, gasoline, hot water, and electricity, wherein the resources 180 can be regulated in addition to and/or over the Internet 175.

IoT devices can communicate with each other to regulate their use of a resource 180. For example, IoT devices such as a toaster, a computer, and a hairdryer may communicate with each other over a Bluetooth communication interface to regulate their use of electricity (the resource 180). As another example, IoT devices such as a desktop computer, a telephone, and a tablet computer may communicate over a Wi-Fi communication interface to regulate their access to the Internet 175 (the resource 180). As yet another example, IoT devices such as a stove, a clothes dryer, and a water heater may communicate over a Wi-Fi communication interface to regulate their use of gas. Alternatively, or additionally, each IoT device may be connected to an IoT server, such as IoT server 170, which has logic to regulate their use of the resource 180 based on information received from the IoT devices.

In accordance with various aspects, FIG. 1E illustrates a high-level architecture of another wireless communications system 100E that contains a plurality of IoT devices. In general, the wireless communications system 100E shown in FIG. 1E may include various components that are the same and/or substantially similar to the wireless communications systems 100A-100D shown in FIGS. 1A-1D, respectively, which were described in greater detail above. As such, for brevity and ease of description, various details relating to certain components in the wireless communications system 100E shown in FIG. 1E may be omitted herein to the extent that the same or similar details have already been provided above in relation to the wireless communications systems 100A-100D illustrated in FIGS. 1A-1D, respectively.

The communications system 100E includes two IoT device groups 160A and 160B. Multiple IoT device groups may be connected to and/or communicate with each other via an IoT SuperAgent connected to the Internet 175. At a high level, an IoT SuperAgent may manage inter-group communications among IoT device groups. For example, in FIG. 1E, the IoT device group 160A includes IoT devices 116A, 122A, and 124A and an IoT SuperAgent 140A, while IoT device group 160B includes IoT devices 116B, 122B, and 124B and an IoT SuperAgent 140B. As such, the IoT SuperAgents 140A and 140B may connect to the Internet 175 and communicate with each other over the Internet 175 and/or communicate with each other directly to facilitate communication between the IoT device groups 160A and 160B. Furthermore, although FIG. 1E illustrates two IoT device groups 160A and 160B communicating with each other via IoT SuperAgents 140A and 140B, those skilled in the art will appreciate that any number of IoT device groups may suitably communicate with each other using IoT SuperAgents.

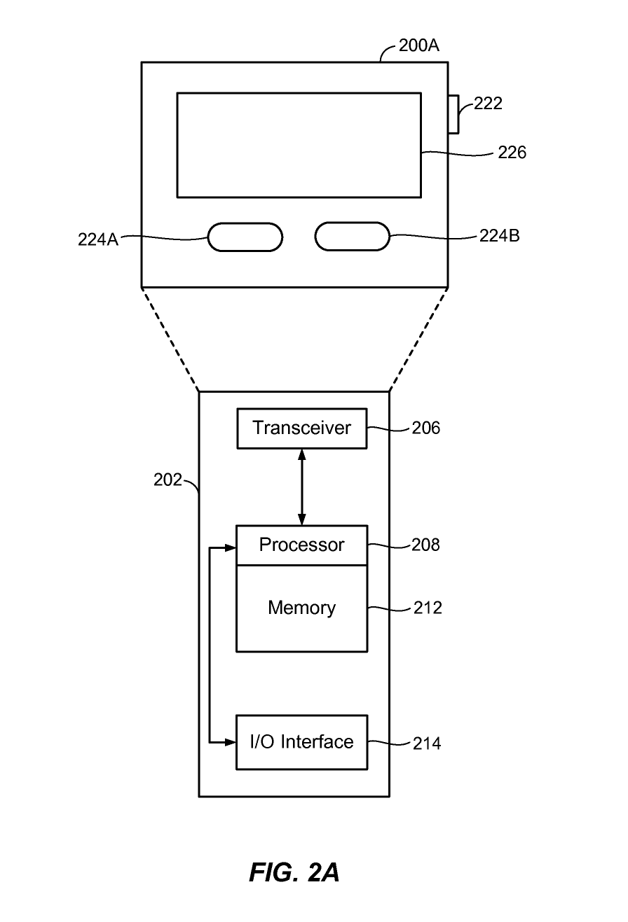

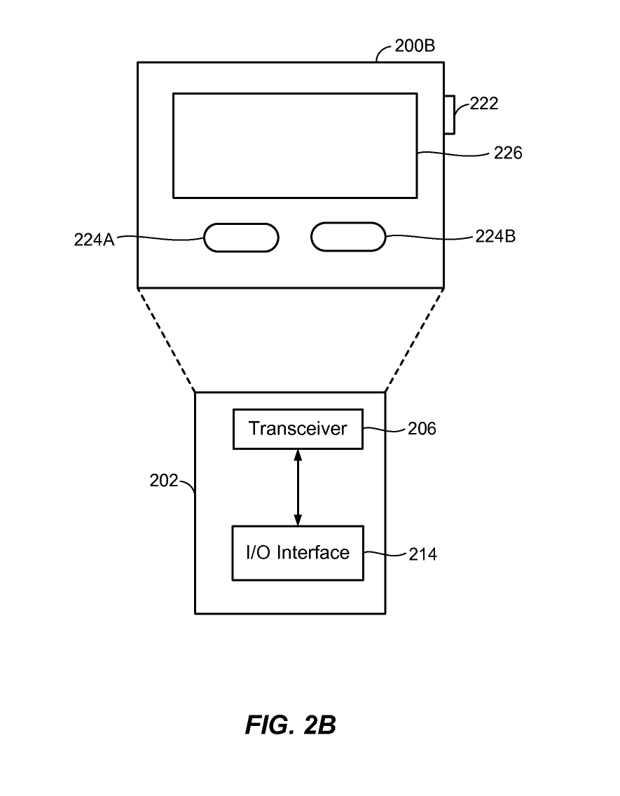

FIG. 2A illustrates a high-level example of an IoT device 200A in accordance with various aspects. While external appearances and/or internal components can differ significantly among IoT devices, most IoT devices will have some sort of user interface, which may comprise a display and a means for user input. IoT devices without a user interface can be communicated with remotely over a wired or wireless network, such as air interface 108 in FIGS. 1A-1B.

As shown in FIG. 2A, in an example configuration for the IoT device 200A, an external casing of IoT device 200A may be configured with a display 226, a power button 222, and two control buttons 224A and 224B, among other components, as is known in the art. The display 226 may be a touchscreen display, in which case the control buttons 224A and 224B may not be necessary. While not shown explicitly as part of IoT device 200A, the IoT device 200A may include one or more external antennas and/or one or more integrated antennas that are built into the external casing, including but not limited to Wi-Fi antennas, cellular antennas, satellite position system (SPS) antennas (e.g., global positioning system (GPS) antennas), and so on.

While internal components of IoT devices, such as IoT device 200A, can be embodied with different hardware configurations, a basic high-level configuration for internal hardware components is shown as platform 202 in FIG. 2A. The platform 202 can receive and execute software applications, data and/or commands transmitted over a network interface, such as air interface 108 in FIGS. 1A-1B and/or a wired interface. The platform 202 can also independently execute locally stored applications. The platform 202 can include one or more transceivers 206 configured for wired and/or wireless communication (e.g., a Wi-Fi transceiver, a Bluetooth transceiver, a cellular transceiver, a satellite transceiver, a GPS or SPS receiver, etc.) operably coupled to one or more processors 208, such as a microcontroller, microprocessor, application specific integrated circuit, digital signal processor (DSP), programmable logic circuit, or other data processing device, which will be generally referred to as processor 208. The processor 208 can execute application programming instructions within a memory 212 of the IoT device. The memory 212 can include one or more of read-only memory (ROM), random-access memory (RAM), electrically erasable programmable ROM (EEPROM), flash cards, or any memory common to computer platforms. One or more input/output (I/O) interfaces 214 can be configured to allow the processor 208 to communicate with and control from various I/O devices such as the display 226, power button 222, control buttons 224A and 224B as illustrated, and any other devices, such as sensors, actuators, relays, valves, switches, and the like associated with the IoT device 200A.

Accordingly, various aspects can include an IoT device (e.g., IoT device 200A) including the ability to perform the functions described herein. As will be appreciated by those skilled in the art, the various logic elements can be embodied in discrete elements, software modules executed on a processor (e.g., processor 208) or any combination of software and hardware to achieve the functionality disclosed herein. For example, transceiver 206, processor 208, memory 212, and I/O interface 214 may all be used cooperatively to load, store and execute the various functions disclosed herein and thus the logic to perform these functions may be distributed over various elements. Alternatively, the functionality could be incorporated into one discrete component. Therefore, the features of the IoT device 200A in FIG. 2A are to be considered merely illustrative and the IoT device 200A is not limited to the illustrated features or arrangement shown in FIG. 2A.

FIG. 2B illustrates a high-level example of a passive IoT device 200B in accordance with various aspects. In general, the passive IoT device 200B shown in FIG. 2B may include various components that are the same and/or substantially similar to the IoT device 200A shown in FIG. 2A, which was described in greater detail above. As such, for brevity and ease of description, various details relating to certain components in the passive IoT device 200B shown in FIG. 2B may be omitted herein to the extent that the same or similar details have already been provided above in relation to the IoT device 200A illustrated in FIG. 2A.

The passive IoT device 200B shown in FIG. 2B may generally differ from the IoT device 200A shown in FIG. 2A in that the passive IoT device 200B may not have a processor, internal memory, or certain other components. Instead, in various embodiments, the passive IoT device 200B may only include an I/O interface 214 or other suitable mechanism that allows the passive IoT device 200B to be observed, monitored, controlled, managed, or otherwise known within a controlled IoT network. For example, in various embodiments, the I/O interface 214 associated with the passive IoT device 200B may include a barcode, Bluetooth interface, radio frequency (RF) interface, RFID tag, IR interface, NFC interface, or any other suitable I/O interface that can provide an identifier and attributes associated with the passive IoT device 200B to another device when queried over a short range interface (e.g., an active IoT device, such as IoT device 200A, that can detect, store, communicate, act on, or otherwise process information relating to the attributes associated with the passive IoT device 200B).

Although the foregoing describes the passive IoT device 200B as having some form of RF, barcode, or other I/O interface 214, the passive IoT device 200B may comprise a device or other physical object that does not have such an I/O interface 214. For example, certain IoT devices may have appropriate scanner or reader mechanisms that can detect shapes, sizes, colors, and/or other observable features associated with the passive IoT device 200B to identify the passive IoT device 200B. In this manner, any suitable physical object may communicate its identity and attributes and be observed, monitored, controlled, or otherwise managed within a controlled IoT network.

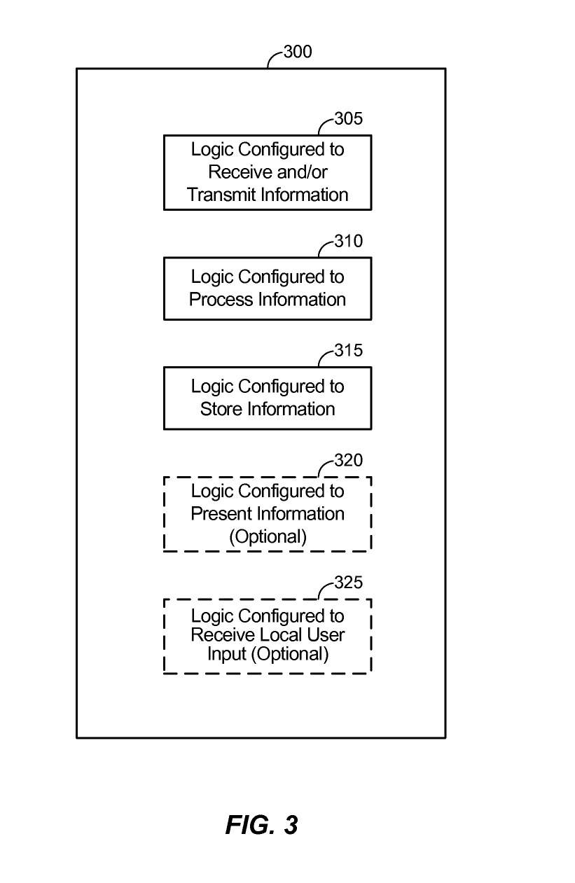

FIG. 3 illustrates a communication device 300 that includes logic configured to perform functionality. The communication device 300 can correspond to any of the above-noted communication devices, including but not limited to IoT devices 110-120, IoT device 200A, any components coupled to the Internet 175 (e.g., the IoT server 170), and so on. Thus, communication device 300 can correspond to any electronic device that is configured to communicate with (or facilitate communication with) one or more other entities over the wireless communications systems 100A-100E of FIGS. 1A-1E.

Referring to FIG. 3, the communication device 300 includes logic configured to receive and/or transmit information 305. In an example, if the communication device 300 corresponds to a wireless communications device (e.g., IoT device 200A and/or passive IoT device 200B), the logic configured to receive and/or transmit information 305 can include a wireless communications interface (e.g., Bluetooth, Wi-Fi, Wi-Fi Direct, Long-Term Evolution (LTE) Direct, etc.) such as a wireless transceiver and associated hardware (e.g., an RF antenna, a MODEM, a modulator and/or demodulator, etc.). In another example, the logic configured to receive and/or transmit information 305 can correspond to a wired communications interface (e.g., a serial connection, a USB or Firewire connection, an Ethernet connection through which the Internet 175 can be accessed, etc.). Thus, if the communication device 300 corresponds to some type of network-based server (e.g., the application 170), the logic configured to receive and/or transmit information 305 can correspond to an Ethernet card, in an example, that connects the network-based server to other communication entities via an Ethernet protocol. In a further example, the logic configured to receive and/or transmit information 305 can include sensory or measurement hardware by which the communication device 300 can monitor its local environment (e.g., an accelerometer, a temperature sensor, a light sensor, an antenna for monitoring local RF signals, etc.). The logic configured to receive and/or transmit information 305 can also include software that, when executed, permits the associated hardware of the logic configured to receive and/or transmit information 305 to perform its reception and/or transmission function(s). However, the logic configured to receive and/or transmit information 305 does not correspond to software alone, and the logic configured to receive and/or transmit information 305 relies at least in part upon hardware to achieve its functionality.

Referring to FIG. 3, the communication device 300 further includes logic configured to process information 310. In an example, the logic configured to process information 310 can include at least a processor. Example implementations of the type of processing that can be performed by the logic configured to process information 310 includes but is not limited to performing determinations, establishing connections, making selections between different information options, performing evaluations related to data, interacting with sensors coupled to the communication device 300 to perform measurement operations, converting information from one format to another (e.g., between different protocols such as .wmv to .avi, etc.), and so on. For example, the processor included in the logic configured to process information 310 can correspond to a general purpose processor, a DSP, an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration). The logic configured to process information 310 can also include software that, when executed, permits the associated hardware of the logic configured to process information 310 to perform its processing function(s). However, the logic configured to process information 310 does not correspond to software alone, and the logic configured to process information 310 relies at least in part upon hardware to achieve its functionality.

Referring to FIG. 3, the communication device 300 further includes logic configured to store information 315. In an example, the logic configured to store information 315 can include at least a non-transitory memory and associated hardware (e.g., a memory controller, etc.). For example, the non-transitory memory included in the logic configured to store information 315 can correspond to RAM, flash memory, ROM, erasable programmable ROM (EPROM), EEPROM, registers, hard disk, a removable disk, a CD-ROM, or any other form of storage medium known in the art. The logic configured to store information 315 can also include software that, when executed, permits the associated hardware of the logic configured to store information 315 to perform its storage function(s). However, the logic configured to store information 315 does not correspond to software alone, and the logic configured to store information 315 relies at least in part upon hardware to achieve its functionality.

Referring to FIG. 3, the communication device 300 further optionally includes logic configured to present information 320. In an example, the logic configured to present information 320 can include at least an output device and associated hardware. For example, the output device can include a video output device (e.g., a display screen, a port that can carry video information such as USB, HDMI, etc.), an audio output device (e.g., speakers, a port that can carry audio information such as a microphone jack, USB, HDMI, etc.), a vibration device and/or any other device by which information can be formatted for output or actually outputted by a user or operator of the communication device 300. For example, if the communication device 300 corresponds to the IoT device 200A as shown in FIG. 2A and/or the passive IoT device 200B as shown in FIG. 2B, the logic configured to present information 320 can include the display 226. In a further example, the logic configured to present information 320 can be omitted for certain communication devices, such as network communication devices that do not have a local user (e.g., network switches or routers, remote servers, etc.). The logic configured to present information 320 can also include software that, when executed, permits the associated hardware of the logic configured to present information 320 to perform its presentation function(s). However, the logic configured to present information 320 does not correspond to software alone, and the logic configured to present information 320 relies at least in part upon hardware to achieve its functionality.

Referring to FIG. 3, the communication device 300 further optionally includes logic configured to receive local user input 325. In an example, the logic configured to receive local user input 325 can include at least a user input device and associated hardware. For example, the user input device can include buttons, a touchscreen display, a keyboard, a camera, an audio input device (e.g., a microphone or a port that can carry audio information such as a microphone jack, etc.), and/or any other device by which information can be received from a user or operator of the communication device 300. For example, if the communication device 300 corresponds to the IoT device 200A as shown in FIG. 2A and/or the passive IoT device 200B as shown in FIG. 2B, the logic configured to receive local user input 325 can include the buttons 222, 224A, and 224B, the display 226 (if a touchscreen), etc. In a further example, the logic configured to receive local user input 325 can be omitted for certain communication devices, such as network communication devices that do not have a local user (e.g., network switches or routers, remote servers, etc.). The logic configured to receive local user input 325 can also include software that, when executed, permits the associated hardware of the logic configured to receive local user input 325 to perform its input reception function(s). However, the logic configured to receive local user input 325 does not correspond to software alone, and the logic configured to receive local user input 325 relies at least in part upon hardware to achieve its functionality.

Referring to FIG. 3, while the configured logics of 305 through 325 are shown as separate or distinct blocks in FIG. 3, it will be appreciated that the hardware and/or software by which the respective configured logic performs its functionality can overlap in part. For example, any software used to facilitate the functionality of the configured logics of 305 through 325 can be stored in the non-transitory memory associated with the logic configured to store information 315, such that the configured logics of 305 through 325 each performs their functionality (i.e., in this case, software execution) based in part upon the operation of software stored by the logic configured to store information 315. Likewise, hardware that is directly associated with one of the configured logics can be borrowed or used by other configured logics from time to time. For example, the processor of the logic configured to process information 310 can format data into an appropriate format before being transmitted by the logic configured to receive and/or transmit information 305, such that the logic configured to receive and/or transmit information 305 performs its functionality (i.e., in this case, transmission of data) based in part upon the operation of hardware (i.e., the processor) associated with the logic configured to process information 310.

Generally, unless stated otherwise explicitly, the phrase “logic configured to” as used herein is intended to refer to logic at least partially implemented with hardware, and is not intended to map to software-only implementations that are independent of hardware. Also, it will be appreciated that the configured logic or “logic configured to” in the various blocks are not limited to specific logic gates or elements, but generally refer to the ability to perform the functionality described herein (either via hardware or a combination of hardware and software). Thus, the configured logics or “logic configured to” as illustrated in the various blocks are not necessarily implemented as logic gates or logic elements despite sharing the word “logic.” Other interactions or cooperation between the logic in the various blocks will become clear to one of ordinary skill in the art from a review of the aspects described below in more detail.

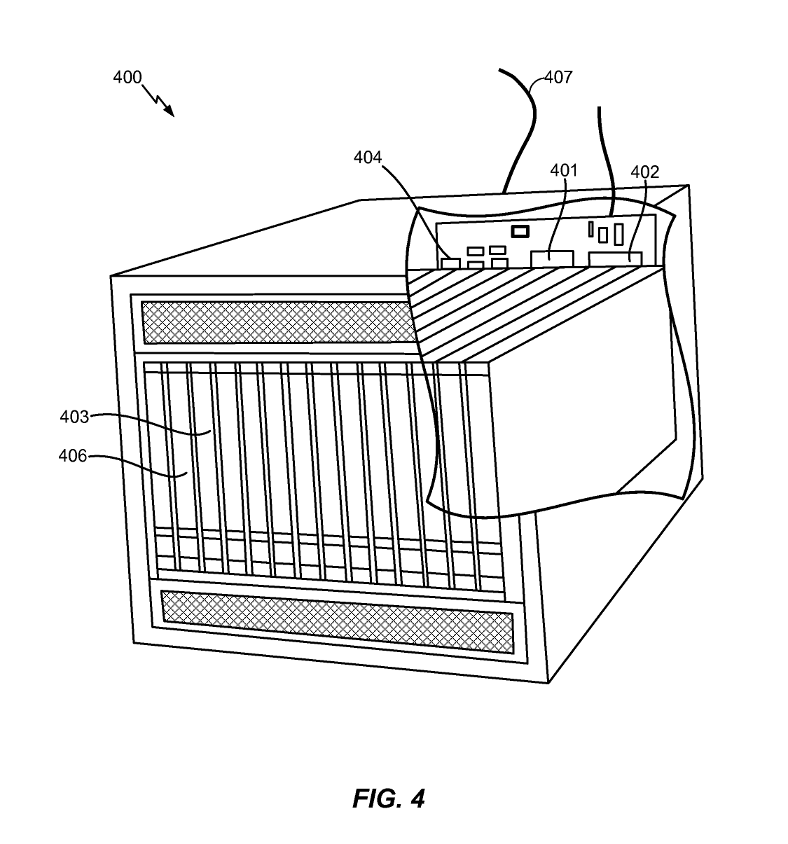

The various embodiments may be implemented on any of a variety of commercially available server devices, such as server 400 illustrated in FIG. 4. In an example, the server 400 may correspond to one example configuration of the IoT server 170 described above. In FIG. 4, the server 400 includes a processor 401 coupled to volatile memory 402 and a large capacity nonvolatile memory, such as a disk drive 403. The server 400 may also include a floppy disc drive, compact disc (CD) or DVD disc drive 406 coupled to the processor 401. The server 400 may also include network access ports 404 coupled to the processor 401 for establishing data connections with a network 407, such as a local area network coupled to other broadcast system computers and servers or to the Internet. In context with FIG. 3, it will be appreciated that the server 400 of FIG. 4 illustrates one example implementation of the communication device 300, whereby the logic configured to transmit and/or receive information 305 corresponds to the network access points 404 used by the server 400 to communicate with the network 407, the logic configured to process information 310 corresponds to the processor 401, and the logic configuration to store information 315 corresponds to any combination of the volatile memory 402, the disk drive 403 and/or the disc drive 406. The optional logic configured to present information 320 and the optional logic configured to receive local user input 325 are not shown explicitly in FIG. 4 and may or may not be included therein. Thus, FIG. 4 helps to demonstrate that the communication device 300 may be implemented as a server, in addition to an IoT device implementation as in FIG. 2A.

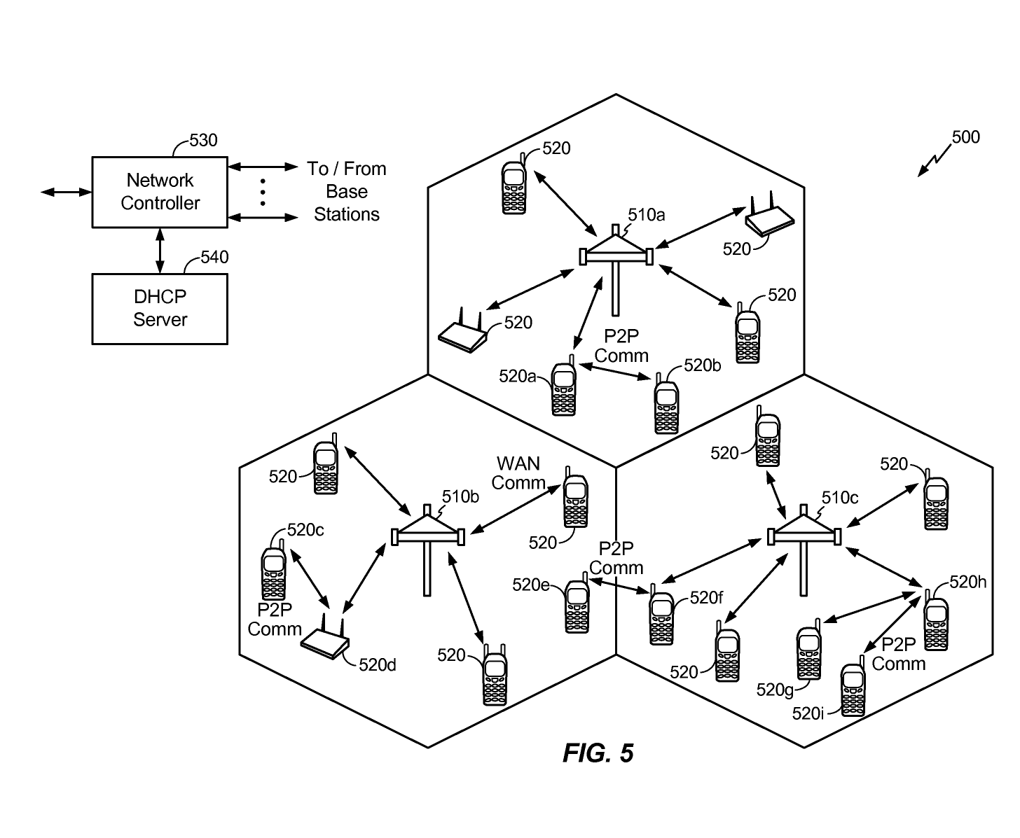

In general, as noted above, IP based technologies and services have become more mature, driving down the cost and increasing availability of IP, which has allowed Internet connectivity to be added to more and more types of everyday electronic objects. As such, the IoT is based on the idea that everyday electronic objects, not just computers and computer networks, can be readable, recognizable, locatable, addressable, and controllable via the Internet. In general, with the development and increasing prevalence of the IoT, numerous proximate heterogeneous IoT devices and other physical objects that have different types and perform different activities (e.g., lights, printers, refrigerators, air conditioners, etc.) may interact with one another in many different ways and be used in many different ways. As such, due to the potentially large number of heterogeneous IoT devices and other physical objects that may be in use within a controlled IoT network, well-defined and reliable communication interfaces are generally needed to connect the various heterogeneous IoT devices such that the various heterogeneous IoT devices can be appropriately configured, managed, and communicate with one another to exchange information, among other things. Accordingly, the following description provided in relation to FIGS. 5-8 generally outlines an exemplary communication framework that may support discoverable peer-to-peer (P2P) services to enable communication among heterogeneous devices in a distributed programming environment as disclosed herein.

In general, user equipment (UE) (e.g., telephones, tablet computers, laptop and desktop computers, vehicles, etc.), can be configured to connect with one another locally (e.g., Bluetooth, local Wi-Fi, etc.), remotely (e.g., via cellular networks, through the Internet, etc.), or according to suitable combinations thereof. Furthermore, certain UEs may also support proximity-based peer-to-peer (P2P) communication using certain wireless networking technologies (e.g., Wi-Fi, Bluetooth, Wi-Fi Direct, etc.) that support one-to-one connections or simultaneously connections to a group that includes several devices directly communicating with one another. To that end, FIG. 5 illustrates an exemplary wireless communication network or WAN 500 that may support discoverable P2P services, wherein the wireless communication network 500 may comprise an LTE network or another suitable WAN that includes various base stations 510 and other network entities. For simplicity, only three base stations 510a, 510b and 510c, one network controller 530, and one Dynamic Host Configuration Protocol (DHCP) server 540 are shown in FIG. 5. A base station 510 may be an entity that communicates with devices 520 and may also be referred to as a Node B, an evolved Node B (eNB), an access point, etc. Each base station 510 may provide communication coverage for a particular geographic area and may support communication for the devices 520 located within the coverage area. To improve network capacity, the overall coverage area of a base station 510 may be partitioned into multiple (e.g., three) smaller areas, wherein each smaller area may be served by a respective base station 510. In 3GPP, the term “cell” can refer to a coverage area of a base station 510 and/or a base station subsystem 510 serving this coverage area, depending on the context in which the term is used. In 3GPP2, the term “sector” or “cell-sector” can refer to a coverage area of a base station 510 and/or a base station subsystem 510 serving this coverage area. For clarity, the 3GPP concept of “cell” may be used in the description herein.

A base station 510 may provide communication coverage for a macro cell, a pico cell, a femto cell, and/or other cell types. A macro cell may cover a relatively large geographic area (e.g., several kilometers in radius) and may allow unrestricted access by devices 520 with service subscription. A pico cell may cover a relatively small geographic area and may allow unrestricted access by devices 520 with service subscription. A femto cell may cover a relatively small geographic area (e.g., a home) and may allow restricted access by devices 520 having association with the femto cell (e.g., devices 520 in a Closed Subscriber Group (CSG)). In the example shown in FIG. 5, wireless network 500 includes macro base stations 510a, 510b and 510c for macro cells. Wireless network 500 may also include pico base stations 510 for pico cells and/or home base stations 510 for femto cells (not shown in FIG. 5).

Network controller 530 may couple to a set of base stations 510 and may provide coordination and control for these base stations 510. Network controller 530 may be a single network entity or a collection of network entities that can communicate with the base stations via a backhaul. The base stations may also communicate with one another, e.g., directly or indirectly via wireless or wireline backhaul. DHCP server 540 may support P2P communication, as described below. DHCP server 540 may be part of wireless network 500, external to wireless network 500, run via Internet Connection Sharing (ICS), or any suitable combination thereof. DHCP server 540 may be a separate entity (e.g., as shown in FIG. 5) or may be part of a base station 510, network controller 530, or some other entity. In any case, DHCP server 540 may be reachable by devices 520 desiring to communicate peer-to-peer.

Devices 520 may be dispersed throughout wireless network 500, and each device 520 may be stationary or mobile. A device 520 may also be referred to as a node, user equipment (UE), a station, a mobile station, a terminal, an access terminal, a subscriber unit, etc. A device 520 may be a cellular phone, a personal digital assistant (PDA), a wireless modem, a wireless communication device, a handheld device, a laptop computer, a cordless phone, a wireless local loop (WLL) station, a smart phone, a netbook, a smartbook, a tablet, etc. A device 520 may communicate with base stations 510 in the wireless network 500 and may further communicate peer-to-peer with other devices 520. For example, as shown in FIG. 5, devices 520a and 520b may communicate peer-to-peer, devices 520c and 520d may communicate peer-to-peer, devices 520e and 520f may communicate peer-to-peer, and devices 520g, 520h, and 520i may communicate peer-to-peer, while remaining devices 520 may communicate with base stations 510. As further shown in FIG. 5, devices 520a, 520d, 520f, and 520h may also communicate with base stations 500, e.g., when not engaged in P2P communication or possibly concurrent with P2P communication.

In the description herein, WAN communication may refer to communication between a device 520 and a base station 510 in wireless network 500, e.g., for a call with a remote entity such as another device 520. A WAN device is a device 520 that is interested or engaged in WAN communication. P2P communication refers to direct communication between two or more devices 520, without going through any base station 510. A P2P device is a device 520 that is interested or engaged in P2P communication, e.g., a device 520 that has traffic data for another device 520 within proximity of the P2P device. Two devices may be considered to be within proximity of one another, for example, if each device 520 can detect the other device 520. In general, a device 520 may communicate with another device 520 either directly for P2P communication or via at least one base station 510 for WAN communication.

In various embodiments, direct communication between P2P devices 520 may be organized into P2P groups. More particularly, a P2P group generally refers to a group of two or more devices 520 interested or engaged in P2P communication and a P2P link refers to a communication link for a P2P group. Furthermore, in various embodiments, a P2P group may include one device 520 designated a P2P group owner (or a P2P server) and one or more devices 520 designated P2P clients that are served by the P2P group owner. The P2P group owner may perform certain management functions such as exchanging signaling with a WAN, coordinating data transmission between the P2P group owner and P2P clients, etc. For example, as shown in FIG. 5, a first P2P group includes devices 520a and 520b under the coverage of base station 510a, a second P2P group includes devices 520c and 520d under the coverage of base station 510b, a third P2P group includes devices 520e and 520f under the coverage of different base stations 510b and 510c, and a fourth P2P group includes devices 520g, 520h and 520i under the coverage of base station 510c. Devices 520a, 520d, 520f, and 520h may be P2P group owners for their respective P2P groups and devices 520b, 520c, 520e, 520g, and 520i may be P2P clients in their respective P2P groups. The other devices 520 in FIG. 5 may be engaged in WAN communication.

In various embodiments, P2P communication may occur only within a P2P group and may further occur only between the P2P group owner and the P2P clients associated therewith. For example, if two P2P clients within the same P2P group (e.g., devices 520g and 520i) desire to exchange information, one of the P2P clients may send the information to the P2P group owner (e.g., device 520h) and the P2P group owner may then relay transmissions to the other P2P client. In various embodiments, a particular device 520 may belong to multiple P2P groups and may behave as either a P2P group owner or a P2P client in each P2P group. Furthermore, in various embodiments, a particular P2P client may belong to only one P2P group or belong to multiple P2P group and communicate with P2P devices 520 in any of the multiple P2P groups at any particular moment. In general, communication may be facilitated via transmissions on the downlink and uplink. For WAN communication, the downlink (or forward link) refers to the communication link from base stations 510 to devices 520, and the uplink (or reverse link) refers to the communication link from devices 520 to base stations 510. For P2P communication, the P2P downlink refers to the communication link from P2P group owners to P2P clients and the P2P uplink refers to the communication link from P2P clients to P2P group owners. In certain embodiments, rather than using WAN technologies to communicate P2P, two or more devices may form smaller P2P groups and communicate P2P on a wireless local area network (WLAN) using technologies such as Wi-Fi, Bluetooth, or Wi-Fi Direct. For example, P2P communication using Wi-Fi, Bluetooth, Wi-Fi Direct, or other WLAN technologies may enable P2P communication between two or more mobile phones, game consoles, laptop computers, or other suitable communication entities.

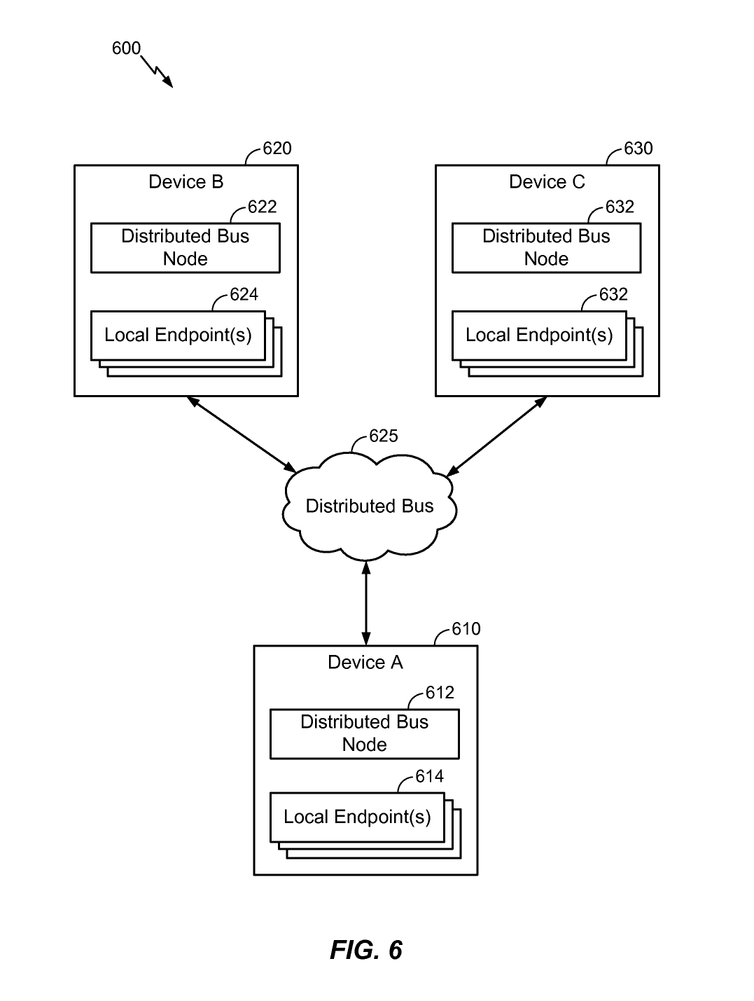

According to various aspects, FIG. 6 illustrates an exemplary environment 600 in which discoverable P2P services may be used to establish a proximity-based distributed bus 625 over which various devices 610, 620, 630 may communicate. For example, in various embodiments, communications between applications and the like, on a single platform may be facilitated using an interprocess communication protocol (IPC) framework over the distributed bus 625, which may comprise a software bus used to enable application-to-application communications in a networked computing environment where applications register with the distributed bus 625 to offer services to other applications and other applications query the distributed bus 625 for information about registered applications. Such a protocol may provide asynchronous notifications and remote procedure calls (RPCs) in which signal messages (e.g., notifications) may be point-to-point or broadcast, method call messages (e.g., RPCs) may be synchronous or asynchronous, and the distributed bus 625 may handle message routing between the various devices 610, 620, 630 (e.g., via one or more bus routers or “daemons” or other suitable processes that may provide attachments to the distributed bus 625).

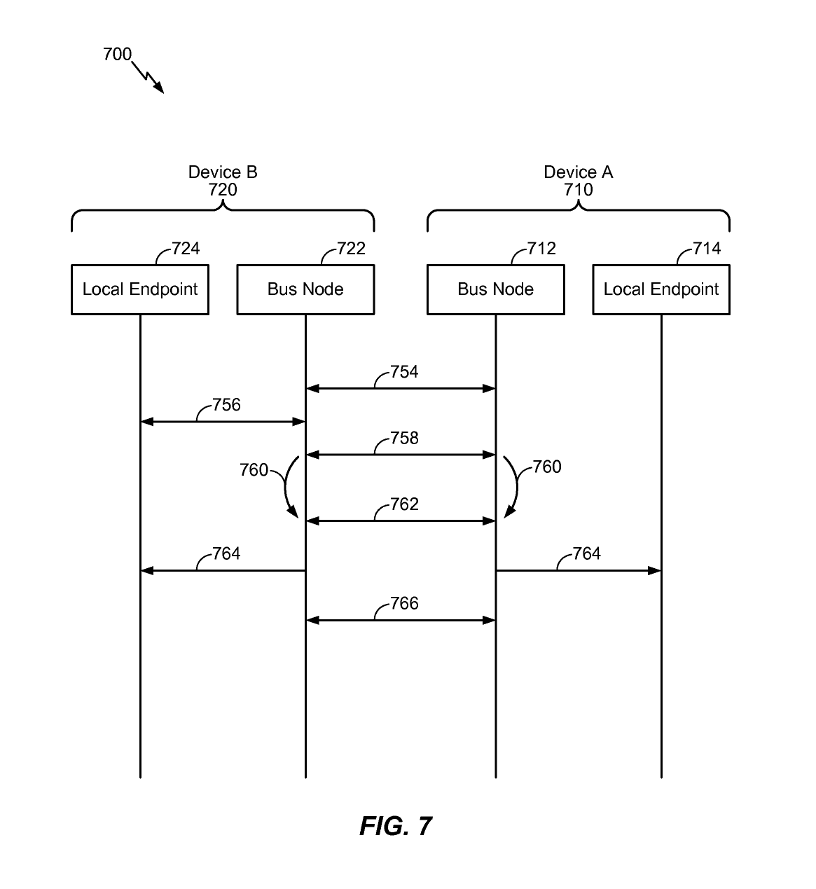

In various embodiments, the distributed bus 625 may be supported by a variety of transport protocols (e.g., Bluetooth, TCP/IP, Wi-Fi, CDMA, GPRS, UMTS, etc.). For example, according to various aspects, a first device 610 may include a distributed bus node 612 and one or more local endpoints 614, wherein the distributed bus node 612 may facilitate communications between local endpoints 614 associated with the first device 610 and local endpoints 624 and 634 associated with a second device 620 and a third device 630 through the distributed bus 625 (e.g., via distributed bus nodes 622 and 632 on the second device 620 and the third device 630). As will be described in further detail below with reference to FIG. 7, the distributed bus 625 may support symmetric multi-device network topologies and may provide a robust operation in the presence of device drops-outs. As such, the virtual distributed bus 625, which may generally be independent from any underlying transport protocol (e.g., Bluetooth, TCP/IP, Wi-Fi, etc.) may allow various security options, from unsecured (e.g., open) to secured (e.g., authenticated and encrypted), wherein the security options can be used while facilitating spontaneous connections with among the first device 610, the second device 620, and the third device 630 without intervention when the various devices 610, 620, 630 come into range or proximity to each other.

According to various aspects, FIG. 7 illustrates an exemplary signaling flow 700 in which discoverable P2P services may be used to establish a proximity-based distributed bus over which a first device (“Device A”) 710 and a second device (“Device B”) 720 may communicate. Generally, Device A 710 may request to communicate with Device B 720, wherein Device A 710 may a include local endpoint 714 (e.g., a local application, service, etc.), which may make a request to communicate in addition to a bus node 712 that may assist in facilitating such communications. Further, Device B 720 may include a local endpoint 724 with which the local endpoint 714 may be attempting to communicate in addition to a bus node 722 that may assist in facilitating communications between the local endpoint 714 on the Device A 710 and the local endpoint 724 on Device B 720.

In various embodiments, the bus nodes 712 and 722 may perform a suitable discovery mechanism at 754. For example, mechanisms for discovering connections supported by Bluetooth, TCP/IP, UNIX, or the like may be used. At 756, the local endpoint 714 on Device A 710 may request to connect to an entity, service, endpoint etc., available through bus node 712. In various embodiments, the request may include a request-and-response process between local endpoint 714 and bus node 712. At 758, a distributed message bus may be formed to connect bus node 712 to bus node 722 and thereby establish a P2P connection between Device A 710 and Device B 720. In various embodiments, communications to form the distributed bus between the bus nodes 712 and 722 may be facilitated using a suitable proximity-based P2P protocol (e.g., the AllJoyn™ software framework designed to enable interoperability among connected products and software applications from different manufacturers to dynamically create proximal networks and facilitate proximal P2P communication). Alternatively, in various embodiments, a server (not shown) may facilitate the connection between the bus nodes 712 and 722. Furthermore, in various embodiments, a suitable authentication mechanism may be used prior to forming the connection between bus nodes 712 and 722 (e.g., SASL authentication in which a client may send an authentication command to initiate an authentication conversation). Still further, at 758, bus nodes 712 and 722 may exchange information about other available endpoints (e.g., local endpoints 634 on Device C 630 in FIG. 6). In such embodiments, each local endpoint that a bus node maintains may be advertised to other bus nodes, wherein the advertisement may include unique endpoint names, transport types, connection parameters, or other suitable information.

In various embodiments, at 760, bus node 712 and bus node 722 may use obtained information associated with the local endpoints 724 and 714, respectively, to create virtual endpoints that may represent the real obtained endpoints available through various bus nodes. In various embodiments, message routing on the bus node 712 may use real and virtual endpoints to deliver messages. Further, there may one local virtual endpoint for every endpoint that exists on remote devices (e.g., Device A 710). Still further, such virtual endpoints may multiplex and/or de-multiplex messages sent over the distributed bus (e.g., a connection between bus node 712 and bus node 722). In various embodiments, virtual endpoints may receive messages from the local bus node 712 or 722, just like real endpoints, and may forward messages over the distributed bus. As such, the virtual endpoints may forward messages to the local bus nodes 712 and 722 from the endpoint multiplexed distributed bus connection. Furthermore, in various embodiments, virtual endpoints that correspond to virtual endpoints on a remote device may be reconnected at any time to accommodate desired topologies of specific transport types. In such embodiments, UNIX based virtual endpoints may be considered local and as such may not be considered candidates for reconnection. Further, TCP-based virtual endpoints may be optimized for one hop routing (e.g., each bus node 712 and 722 may be directly connected to each other). Still further, Bluetooth-based virtual endpoints may be optimized for a single pico-net (e.g., one master and n slaves) in which the Bluetooth-based master may be the same bus node as a local master node.

In various embodiments, the bus node 712 and the bus node 722 may exchange bus state information at 762 to merge bus instances and enable communication over the distributed bus. For example, in various embodiments, the bus state information may include a well-known to unique endpoint name mapping, matching rules, routing group, or other suitable information. In various embodiments, the state information may be communicated between the bus node 712 and the bus node 722 instances using an interface with local endpoints 714 and 724 communicating with using a distributed bus based local name. In another aspect, bus node 712 and bus node 722 may each may maintain a local bus controller responsible for providing feedback to the distributed bus, wherein the bus controller may translate global methods, arguments, signals, and other information into the standards associated with the distributed bus. The bus node 712 and the bus node 722 may communicate (e.g., broadcast) signals at 764 to inform the respective local endpoints 714 and 724 about any changes introduced during bus node connections, such as described above. In various embodiments, new and/or removed global and/or translated names may be indicated with name owner changed signals. Furthermore, global names that may be lost locally (e.g., due to name collisions) may be indicated with name lost signals. Still further, global names that are transferred due to name collisions may be indicated with name owner changed signals and unique names that disappear if and/or when the bus node 712 and the bus node 722 become disconnected may be indicated with name owner changed signals.

As used above, well-known names may be used to uniquely describe local endpoints 714 and 724. In various embodiments, when communications occur between Device A 710 and Device B 720, different well-known name types may be used. For example, a device local name may exist only on the bus node 712 associated with Device A 710 to which the bus node 712 directly attaches. In another example, a global name may exist on all known bus nodes 712 and 722, where only one owner of the name may exist on all bus segments. In other words, when the bus node 712 and bus node 722 are joined and any collisions occur, one of the owners may lose the global name. In still another example, a translated name may be used when a client is connected to other bus nodes associated with a virtual bus. In such embodiments, the translated name may include an appended end (e.g., a local endpoint 714 with well-known name “org.foo” connected to the distributed bus with Globally Unique Identifier “1234” may be seen as “G1234.org.foo”).

In various embodiments, the bus node 712 and the bus node 722 may communicate (e.g., broadcast) signals at 766 to inform other bus nodes of changes to endpoint bus topologies. Thereafter, traffic from local endpoint 714 may move through virtual endpoints to reach intended local endpoint 724 on Device B 720. Further, in operation, communications between local endpoint 714 and local endpoint 724 may use routing groups. In various embodiments, routing groups may enable endpoints to receive signals, method calls, or other suitable information from a subset of endpoints. As such, a routing name may be determined by an application connected to a bus node 712 or 722. For example, a P2P application may use a unique, well-known routing group name built into the application. Further, bus nodes 712 and 722 may support registering and/or de-registering of local endpoints 714 and 724 with routing groups. In various embodiments, routing groups may have no persistence beyond a current bus instance. In another aspect, applications may register for their preferred routing groups each time they connect to the distributed bus. Still further, groups may be open (e.g., any endpoint can join) or closed (e.g., only the creator of the group can modify the group). Yet further, a bus node 712 or 722 may send signals to notify other remote bus nodes or additions, removals, or other changes to routing group endpoints. In such embodiments, the bus node 712 or 722 may send a routing group change signal to other group members whenever a member is added and/or removed from the group. Further, the bus node 712 or 722 may send a routing group change signal to endpoints that disconnect from the distributed bus without first removing themselves from the routing group.

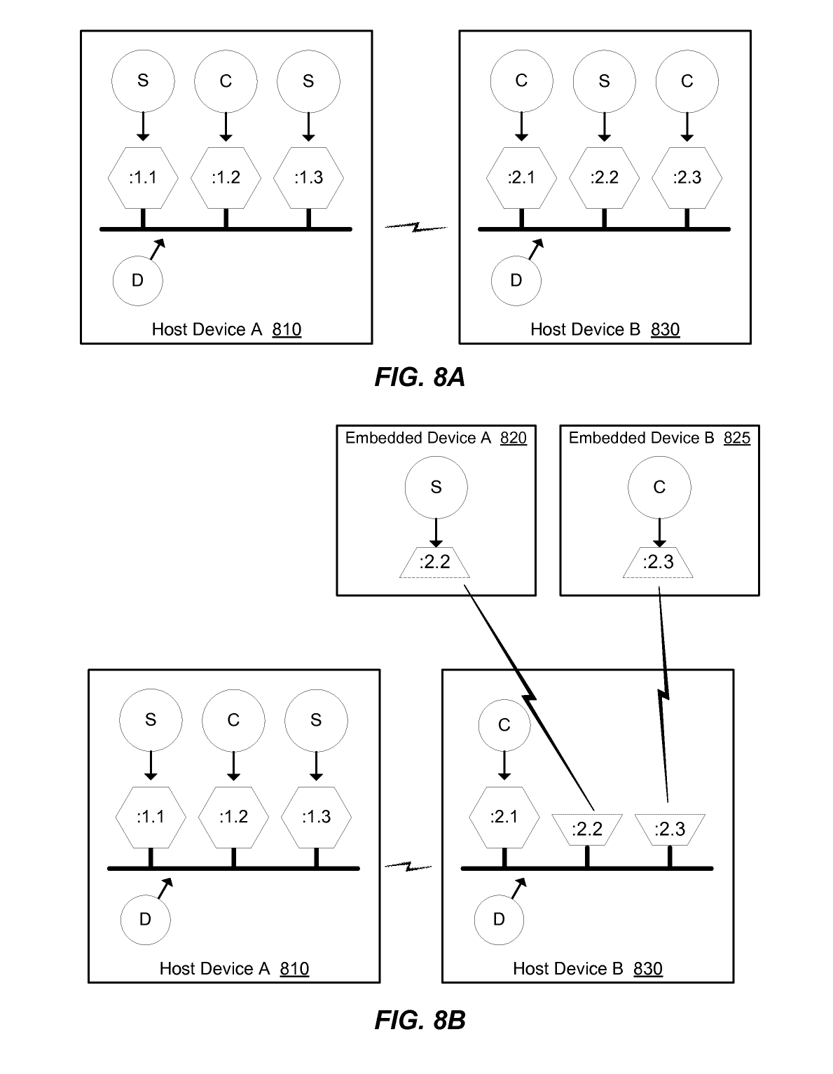

According to various aspects, FIG. 8A illustrates an exemplary proximity-based distributed bus that may be formed between a first host device 810 and a second host device 830. More particularly, as described above with respect to FIG. 6, the basic structure of the proximity-based distributed bus may comprise multiple bus segments that reside on separate physical host devices. Accordingly, in FIG. 8A, each segment of the proximity-based distributed bus may be located on one of the host devices 810, 830, wherein the host devices 810, 830 each execute a local bus router (or “daemon”) that may implement the bus segments located on the respective host device 810, 830. For example, in FIG. 8A, each host device 810, 830 includes a bubble labeled “D” to represent the bus router that implements the bus segments located on the respective host device 810, 830. Furthermore, one or more of the host devices 810, 830 may have several bus attachments, where each bus attachment connects to the local bus router. For example, in FIG. 8A, the bus attachments on host devices 810, 830 are illustrated as hexagons that each correspond to either a service (S) or a client (C) that may request a service.

However, in certain cases, embedded devices may lack sufficient resources to run a local bus router. Accordingly, FIG. 8B illustrates an exemplary proximity-based distributed bus in which one or more embedded devices 820, 825 can connect to a host device (e.g., host device 830) to connect to the proximity-based distributed bus. As such, the embedded devices 820, 825 may generally “borrow” the bus router running on the host device 830, whereby FIG. 8B shows an arrangement where the embedded devices 820, 825 are physically separate from the host device 830 running the borrowed bus router that manages the distributed bus segment on which the embedded devices 820, 825 reside. In general, the connection between the embedded devices 820, 825 and the host device 830 may be made according to the Transmission Control Protocol (TCP) and the network traffic flowing between the embedded devices 820, 825 and the host device 830 may comprise messages that implement bus methods, bus signals, and properties flowing over respective sessions in a similar manner to that described in further detail above with respect to FIGS. 6 and 7. In particular, the embedded devices 820, 825 may connect to the host device 830 according to a discovery and connection process that may be conceptually similar to the discovery and connection process between clients and services, wherein the host device 830 may advertise a well-known name (e.g., “org.alljoyn.BusNode”) that signals an ability or willingness to host the embedded devices 820, 825. In one use case, the embedded devices 820, 825 may simply connect to the “first” host device that advertises the well-known name. However, if the embedded devices 820, 825 simply connect to the first host device that advertises the well-known name, the embedded devices 820, 825 may not have any knowledge about the type associated with the host device (e.g., whether the host device 830 is a mobile device, a set-top box, an access point, etc.), nor would the embedded devices 820, 825 have any knowledge about the load status on the host device. Accordingly, in other use cases, the embedded devices 820, 825 may adaptively connect to the host device 830 based on information that the host devices 810, 830 provide when advertising the ability or willingness to host other devices (e.g., embedded devices 820, 825), which may thereby join the proximity-based distributed bus according to properties associated with the host devices 810, 830 (e.g., type, load status, etc.) and/or requirements associated with the embedded devices 820, 825 (e.g., a ranking table that expresses a preference to connect to a host device from the same manufacturer).

As noted above, IP based technologies and services have become more mature, driving IP costs down while increasing IP availability, whereby Internet connectivity can be added to more and more everyday electronic objects. The IoT is based on the idea that everyday electronic objects, not just computers and computer networks, can be readable, recognizable, locatable, addressable, and controllable via the Internet. In general, with the development and increasing prevalence of the IoT, numerous heterogeneous IoT devices that perform different activities and interact with one another in many different ways will surround user in environments that include homes, workplaces, vehicles, shopping centers, and various other locations. As such, application providers may want to develop and host cloud-based services for certain IoT devices and other things that a user may have, interact with, and otherwise use in an IoT network or other suitable personal space associated with the user. Accordingly, the following description may provide various mechanisms that can be used to dynamically discover cloud-based services for IoT devices in an IoT network associated with a user and offer the discovered cloud-based services to the user.

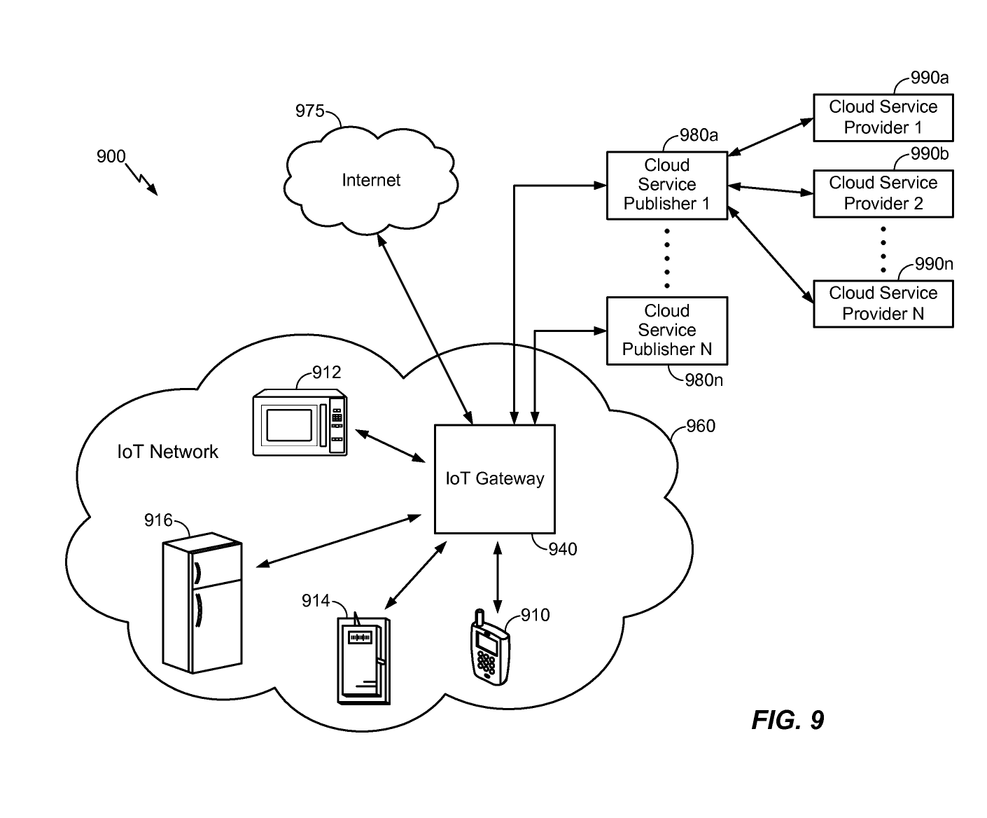

More particularly, according to various aspects, FIG. 9 illustrates an exemplary system 900 that may discover cloud-based services for IoT devices in an IoT network 960 associated with a user and offer the discovered cloud-based services to the user, wherein the IoT network 960 associated with the user may include various connected (or active) IoT devices and various passive IoT devices. For example, in FIG. 9, the IoT network 960 may include a mobile phone IoT device 910, a microwave IoT device 912, a thermostat IoT device 914, and a refrigerator IoT device 916, which may connect to and/or communicate with one another via an IoT gateway 940 that connects to the Internet 975. However, those skilled in the art will appreciate that the IoT devices 910-916 shown in FIG. 9 are exemplary only, and that the IoT network 960 shown therein may include any suitable number and/or combination of IoT devices. In any case, each IoT device 910-916 can treat the IoT gateway 940 as a peer and transmit attribute/schema updates to the IoT gateway 940 according to an appropriate peer-to-peer protocol and each IoT device 910-916 may further request information from the IoT gateway 940 (e.g., a pointer) that can be used to communicate with other IoT devices as a peer according to the peer-to-peer protocol (e.g., the proximity-based peer-to-peer protocol described above in connection with FIGS. 5-8). As such, in accordance with various aspects, the IoT network 960 shown in FIG. 9 may generally be implemented in the wireless communications systems 100A-100E shown in FIGS. 1A-1E and/or implement the peer-to-peer communication mechanisms described above in connection with FIGS. 5-8, whereby the system 900 shown in FIG. 9 may include various components and functions that are the same and/or substantially similar to those described above with respect to FIGS. 1-8. As such, for brevity and ease of description, various details relating to certain components and functions implemented in the system 900 shown in FIG. 9 may be omitted herein to the extent that the same or similar details have already been provided above.

According to one exemplary aspect, one or more cloud service providers (e.g., cloud service providers 990a, 990b, 990n) may develop one or more cloud-based services for certain IoT devices and tag the developed cloud-based services with certain criteria. More particularly, in various embodiments, the cloud-based services may be tagged with one or more device classes that indicate IoT devices for which the cloud-based services were developed. For example, in various embodiments, any particular IoT device may belong to a generic device class and/or one or more specific device classes, wherein the specific device classes may indicate specific capabilities or other features associated with the IoT device (e.g., in the IoT network 960 shown in FIG. 9, the refrigerator IoT device 916 may belong to a generic “refrigerator” device class and a more specific “freezerless” device class). Further, each generic device class and each specific device class may have one or more well-known interfaces that may expose certain functionalities, which the cloud service providers 990a-990n may use to build or otherwise develop services to support IoT devices that belong to certain generic device classes and/or specific device classes. For example, in various embodiments, cloud service provider 990a may build a service that can provide recipe options based on a refrigerator inventory and the service may provide further options or functions that can be used for a refrigerator having display capabilities.

In various embodiments, the cloud service providers 990a-990n may then publish the cloud-based services that they develop to one or more cloud service publishers. For example, as shown in FIG. 9, cloud service providers 990a, 990b, and 990n may publish the cloud-based services that they develop to a first cloud service publisher 980a, while other cloud service providers (not shown) may publish their cloud-based services to another cloud service publisher 980n. Accordingly, the IoT gateway 940 may discover the generic and/or specific device classes associated with the various IoT devices 910-916 in the IoT network 960 associated with the user, discover hosted cloud-based services available for the discovered generic and/or specific device classes from the cloud service publishers 980a-990n, and the offer the discovered cloud-based services to the user. As such, one or multiple cloud service publishers 980 may be provisioned at the IoT gateway 940, which may periodically discover the hosted cloud-based services from the provisioned cloud service publishers 980 to determine the latest cloud-based services available. Furthermore, the IoT gateway 940 may discover multiple cloud-based services that are offered for the same or substantially similar functionality based on interactions with the cloud service publishers 980 (e.g., a particular cloud service publisher 980 may group cloud-based services with similar functions when responding to the IoT gateway 940, group cloud-based services into different categories, such as diagnostic services, analytic services, streaming services, etc. such that new services published from the cloud service providers 990 are assigned to one or more of the categories). Furthermore, although shown as separate entities in FIG. 9, those skilled in the art will appreciate that any particular cloud service publisher 980 may act as a cloud service provider 990 as well.

In various embodiments, in response to suitably discovering the generic and/or specific device classes associated with the various IoT devices 910-916 in the IoT network 960 and the hosted cloud-based services available for the discovered generic and/or specific device classes, the IoT gateway 940 may then offer the discovered cloud-based services to the user associated with the IoT network 960 (e.g., the IoT gateway 940 may discover and offer cloud-based services to provide recipe options based on an inventory in the refrigerator IoT device 916 and/or pantry, obtain insurance on leather furniture, preventatively monitor and diagnose appliances, etc.). For example, in various embodiments, a cloud-based preventive monitoring and diagnostic service may periodically query state information associated with a water heater IoT device (not shown) and identify potential issues based on state information collected over time, which may be useful in preventing serious damages to the water IoT device through early incident detection. In another example, a cloud-based usage analytics service may periodically query state information associated with an air conditioning and heating system, which may be useful in managing utility bills or otherwise monitoring usage patterns. Furthermore, the cloud-based services that are offered to the user through the IoT gateway 940 may be paid or free. In any case, the user may decide whether to request or otherwise make use of any cloud-based services offered through the IoT gateway 940, and if the user requests any cloud-based services, the IoT gateway 940 may interact with the appropriate cloud service publisher 980 to invoke the requested cloud-based services. For example, in various embodiments, the IoT gateway 940 may fetch any data that may be required to invoke the requested cloud-based services from the IoT devices 910-916 in the corresponding device classes, wherein the cloud-based services may use the interfaces that the corresponding device classes expose to perform appropriate get/set operations on properties/actions that the IoT devices 910-916 expose. Furthermore, in certain use cases (e.g., where the cloud service publisher 980 and the cloud service provider 990 are different entities), the cloud service publisher 980 may connect with the cloud service provider 990 that hosts the requested cloud-based services in order to invoke the requested cloud-based services.

In various embodiments, in addition to the generic and/or specific device classes, the cloud-based service discovery that the IoT gateway 940 performs may further depend on usage, contexts, and other state information obtained from the IoT devices 910-916 in the IoT network 960, a profile associated with the user, associations among different users (e.g., different users associated with the IoT network 960, friends or other peer users), location or other personal space associations, temporal associations, rankings, and/or other suitable information sources that may provide relevant real-time knowledge about the IoT network 960, which may collectively be referred to as n-tuple information. For example, if the n-tuple information includes usage information indicating that the user typically uses a coffee grinder in the IoT network 960 to grind spices and seeds (rather than coffee beans), the IoT gateway 940 may discover cloud-based services that may offer benefits associated with those spices and seeds and recipes that use those spices and seeds. In another example, if the n-tuple information includes usage information indicating that the user has a leather sectional sofa that gets used quite often, the IoT gateway 940 may discover cloud-based services that may offer furniture insurance. With respect to state information, the IoT gateway 940 may connect the user to a carpet cleaning service in response to a vacuum cleaner reporting that a carpet needs professional cleaning or connect the user to a local plumbing service in response to a water heater reporting a leak. With respect to user profiles, the IoT gateway 940 may connect the user to a cloud-based audio streaming service that offers nursery rhymes in a first language associated with the user or a video streaming service that offers educational videos in the user's first language in response to the user profile information indicating that the user has a toddler. Furthermore, the cloud-based services available through the cloud service publishers 980 and/or the cloud service providers 990 may be tagged with specific make and model information associated with IoT devices intended to consume the cloud-based services, wherein the IoT gateway 940 may use the device make and model tags to discover the appropriate cloud-based services to offer to the user associated with the IoT network 960. Further still, the cloud-based services may be tagged with any required and/or optional capabilities that the cloud-based services require (e.g., in addition to and/or besides the device classes used to tag the cloud-based services). Accordingly, the cloud-based service discovery that the IoT gateway 940 performs may be further based on the tags associated with the cloud-based services available through the cloud service publishers 980 and/or the cloud service providers 990.

In various embodiments, the cloud service providers 990, the cloud service publishers 980, the IoT gateway 940, and the IoT devices 910-916 in the IoT network 960 may use a common device class dictionary or other suitable semantics to facilitate and simplify communication therebetween, wherein the common device class dictionary or other suitable semantics may be defined and agreed upon among the various parties that are involved in providing the cloud-based services. For example, in various embodiments, each cloud-based service may be identified according to a reverse domain style service name, wherein each service name may have a globally unique identifier (GUID) at the end to distinguish among multiple instances that correspond to the same service (e.g., each instance of a refrigerator diagnostics service available from Sears may be named according to a com.sears.refrigerator.diagnostics.<service_GUID> syntax). As such, in various embodiments, the IoT gateway 940 may filter relevant cloud-based services for each IoT device 910-916 in the IoT network 960 according to metadata used to tag the discovered cloud-based services and the device classes, capabilities, and/or other suitable n-tuple information associated with the IoT network 960, wherein the filtered cloud-based services may then be presented to the IoT devices 910-916 in the IoT network 960. Accordingly, in various embodiments, the IoT devices 910-916 in the IoT network 960 may select one or more relevant cloud services (rather than and/or in addition to the user selecting relevant cloud services), wherein the IoT devices 910-916 may select relevant cloud services based on criteria that relates to device manufacturers, the cloud service providers 990 and/or cloud service publishers 980 through which the cloud-based services are available, functionality associated with the available cloud-based services, and/or cooperation or collaboration with other IoT devices 910-916, among other things. For example, in various embodiments, a Sears washer could select a cloud-based diagnostic service offered through Sears rather than LG or some other manufacturer. In another example, if two cloud-based service providers 990 offer a diagnostics service associated with a particular IoT device 910-916 and neither cloud-based service provider 990 matches a manufacturer associated with the IoT device 910-916, the diagnostics service that runs more frequently may be selected (e.g., daily versus weekly).

In various embodiments, once an IoT device 910-916 selects a particular cloud-based service, the IoT device 910-916 may then request the selected cloud-based service through the IoT gateway 940, which may invoke the requested cloud-based service in a similar manner to that described above with respect to user-requested cloud-based services. Furthermore, in various embodiments, certain cloud-based services may require explicit or implicit approval from the user before provisioning or otherwise activating a cloud-based service that an IoT device 910-916 requested, in which case the IoT gateway 940 may request approval from the user prior to activating such cloud-based services and either reject or provision such cloud-based services depending on whether or not the user indicates approval. Alternatively (or additionally), certain cloud-based services may be automatically activated based on a configuration associated with the IoT gateway 940. For example, in various embodiments, the user may configure the IoT gateway 940 such that cloud-based services selected by IoT devices 910-916 that are free or have a cost below a certain threshold can be automatically activated (e.g., cloud-based services that have a recurring cost under a certain threshold, such as $X per-month or $Y per-year, cloud-based services that have a one-time cost less than a certain value, etc.).

In various embodiments, as noted above, cooperation or collaboration among the IoT devices 910-916 may be enabled such that the IoT devices 910-916 may cooperate or collaborate to determine criteria used to select relevant cloud services that are offered in the IoT network 960. In this context, each IoT device 910-916 may advertise information associated therewith through a particular service in order to tell the IoT gateway 940 and the other IoT devices 910-916 in the IoT network 960 information about the advertising IoT devices 910-916 (e.g., device manufacturer, make, model, etc., device name, supported interfaces, supported functionality, etc.). Furthermore, in various embodiments, the advertised information may indicate certain cloud-based services that the advertising IoT devices 910-916 have already selected, which may include the names, cloud service providers 990, and metadata (e.g., device class, make, model, etc.) associated with the selected cloud-based services. Accordingly, when a new IoT device 910-916 registers with or otherwise joins the IoT network 960, the new IoT device 910-916 may obtain the information advertised from the other IoT devices in the IoT network 960 (e.g., over a multicast service) and use the advertised information to determine the criteria used when selecting its own cloud-based services (e.g., based on cloud-based services that similar IoT devices 910-916 have already selected). For example, if a Sears washer/dryer has selected a cloud-based diagnostics services available through Sears, a KitchenAid dishwasher may decide to select the same service despite the difference in the manufacturer in order to have all diagnostics services managed through the same service provider.

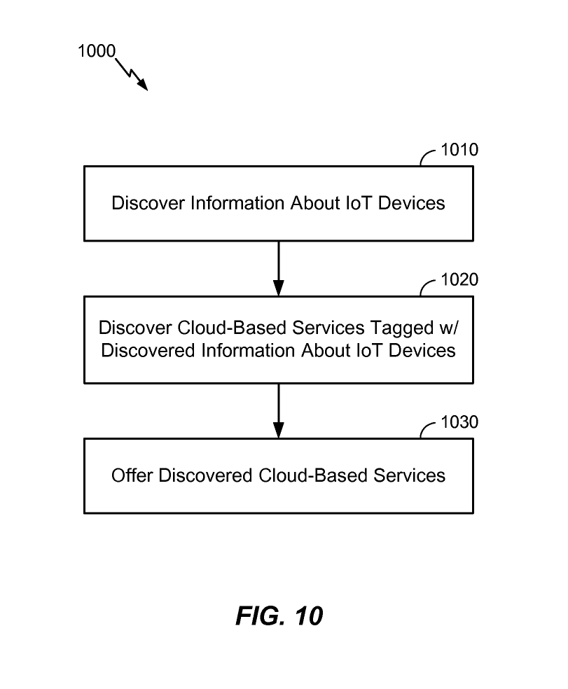

According to various aspects, FIG. 10 illustrates an exemplary method 1000 to discover and offer cloud-based services in an IoT network associated with a user. In particular, the IoT network may include an IoT gateway and one or more IoT devices, wherein each IoT device in the IoT network can treat the IoT gateway as a peer and transmit attribute/schema updates to the IoT gateway according to an appropriate peer-to-peer protocol such that the IoT gateway may discover information about the IoT devices at block 1010. Furthermore, each IoT device may further request information from the IoT gateway (e.g., a pointer) that can be used to communicate with other IoT devices as peers according to the peer-to-peer protocol. In various embodiments, each IoT device may belong to a generic device class and/or one or more specific device classes, wherein the specific device classes may indicate specific capabilities or other features associated with the IoT device. Furthermore, each generic and specific device class may have one or more well-known interfaces that may expose certain functionalities, which cloud service providers may use to build or otherwise develop services to support IoT devices that belong to certain generic device classes and/or specific device classes. For example, in various embodiments, cloud service provider may build a service that can provide recipe options based on a refrigerator inventory and the service may provide further options or functions that can be used for a refrigerator having display capabilities. Accordingly, at block 1010, the IoT gateway may discover the generic and/or specific device classes associated with the various IoT devices in the IoT network associated with the user and further discover hosted cloud-based services available for the discovered generic and/or specific device classes from the cloud service publishers at block 1020. For example, in various embodiments, one or multiple cloud service publishers may be provisioned at the IoT gateway, which may periodically discover the hosted cloud-based services from the provisioned cloud service publishers at block 1020 to determine the latest cloud-based services available. Furthermore, the IoT gateway may discover multiple cloud-based services that are offered for the same or substantially similar functionality based on interactions with the cloud service publishers. In various embodiments, having discovered the information about the various IoT devices in the IoT network and the cloud-based services tagged with the discovered information about the IoT devices in the IoT network, the IoT gateway may then offer the discovered cloud-based services within the IoT network at block 1030.

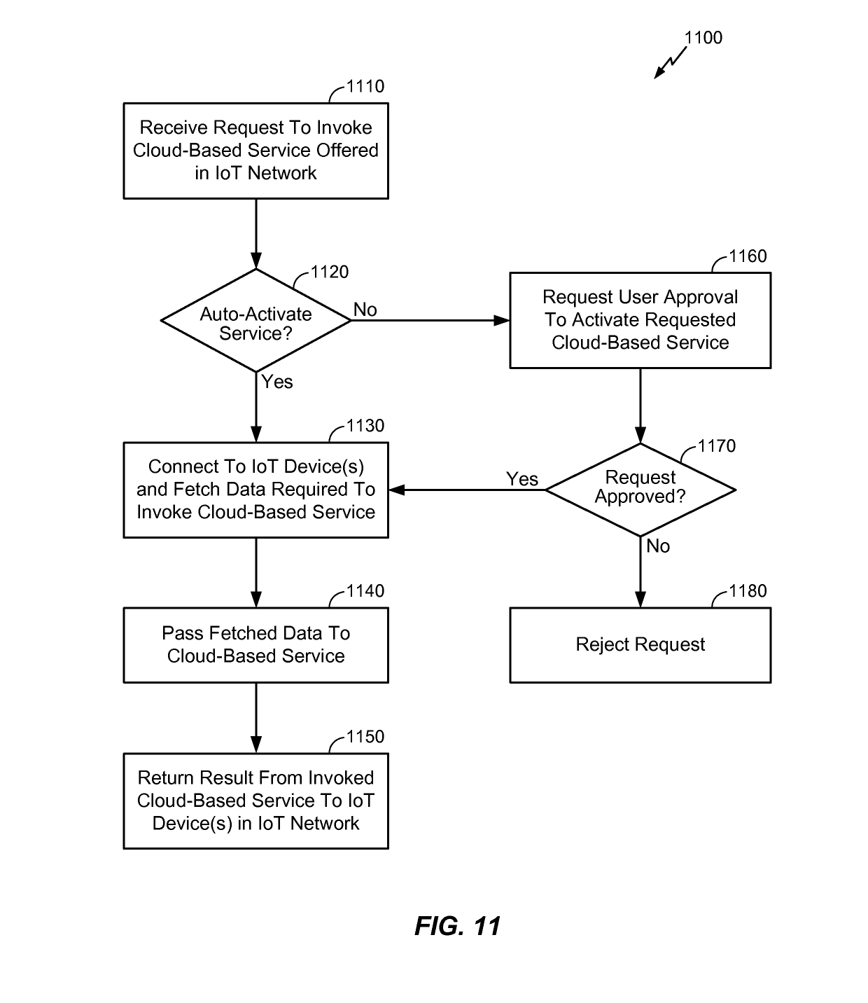

According to various aspects, FIG. 11 illustrates an exemplary method 1100 to service requests to invoke cloud-based services offered in an IoT network. More particularly, subsequent to an IoT gateway or other suitable device in an IoT network discovering one or more cloud-based services to offer in the IoT network, the IoT gateway may receive a request to invoke to otherwise make use of one or more of the discovered cloud-based services offered in the IoT network at block 1110, wherein a user associated with the IoT network and/or an IoT device within the IoT network may initiate the request that the IoT gateway receives at block 1110. In various embodiments, the IoT gateway may then determine whether to auto-activate the requested cloud-based service at block 1120. For example, in various embodiments, the IoT gateway may be configured such that requested cloud-based services that are available for free or for less than a certain cost can be automatically activated (e.g., cloud-based services that have a recurring cost under a certain threshold, such as $X per-month or $Y per-year, cloud-based services that have a one-time cost less than a certain value, etc.). Furthermore, in various embodiments, the IoT gateway may be configured such that certain cloud-based services require explicit or implicit approval before the cloud-based services can be provisioned or otherwise activated (e.g., any cloud-based services for which an IoT device initiates the request, cloud-based services that have a recurring and/or one-time cost that equals or exceeds an auto-activate threshold, etc.). Accordingly, in response to determining that the requested cloud-based service can be automatically activated, the IoT gateway may fetch any data that may be required to invoke the requested cloud-based services from the IoT devices at block 1130 (e.g., using the interfaces that the corresponding device classes expose to perform appropriate get/set operations on properties/actions that the IoT devices expose), pass the fetched data to the appropriate cloud-based service to thereby invoke the requested cloud-based service at block 1140, and return the result from the invoked cloud-based service to the IoT devices within the IoT network at block 1150. However, in the event that the requested cloud-based service requires implicit or explicit approval from a user, block 1160 may comprise requesting the approval from the user prior to activating the requested cloud-based service or otherwise initiating a procedure to invoke the cloud-based service. In response to determining that the request was approved at block 1170, the IoT gateway may connect to the appropriate IoT devices to fetch the data required to invoke the requested cloud-based services, pass the fetched data to the appropriate cloud-based service to invoke the requested cloud-based service, and return the result from the invoked cloud-based service to the IoT devices within the IoT network at blocks 1030, 1040, 1050 in the manner described above. However, in response to determining that the request was not approved at block 1170, the IoT gateway may reject the request at block 1180.

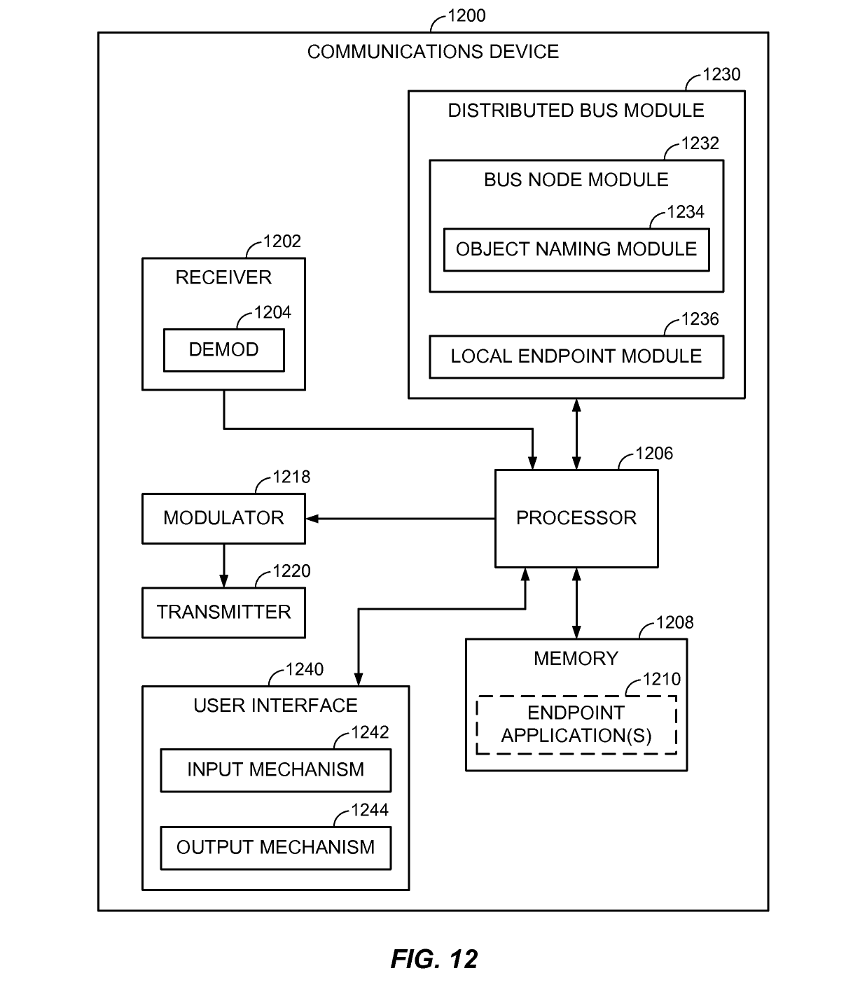

According to various aspects, FIG. 12 illustrates an exemplary communications device 1200 that may communicate over a proximity-based distributed bus using discoverable P2P services in accordance with the various aspects and embodiments disclosed herein. For example, in various embodiments, the communications device 1200 shown in FIG. 12 may correspond to an IoT gateway that discovers and offers cloud-based services within an IoT network, one or more IoT devices in the IoT network, etc. As shown in FIG. 12, the communications device 1200 may comprise a receiver 1202 that may receive a signal from, for instance, a receive antenna (not shown), perform typical actions on the received signal (e.g., filtering, amplifying, downconverting, etc.), and digitize the conditioned signal to obtain samples. The receiver 1202 can comprise a demodulator 1204 that can demodulate received symbols and provide them to a processor 1206 for channel estimation. The processor 1206 can be dedicated to analyzing information received by the receiver 1202 and/or generating information for transmission by a transmitter 1220, control one or more components of the communications device 1200, and/or any suitable combination thereof.

In various embodiments, the communications device 1200 can additionally comprise a memory 1208 operatively coupled to the processor 1206, wherein the memory 1208 can store received data, data to be transmitted, information related to available channels, data associated with analyzed signal and/or interference strength, information related to an assigned channel, power, rate, or the like, and any other suitable information for estimating a channel and communicating via the channel. In various embodiments, the memory 1208 can include one or more local endpoint applications 1210, which may seek to communicate with endpoint applications, services, etc., on the communications device 1200 and/or other communications devices (not shown) through a distributed bus module 1230. The memory 1208 can additionally store protocols and/or algorithms associated with estimating and/or utilizing a channel (e.g., performance based, capacity based, etc.).

Those skilled in the art will appreciate that the memory 1208 and/or other data stores described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 1208 in the subject systems and methods may comprise, without being limited to, these and any other suitable types of memory.

In various embodiments, the distributed bus module 1230 associated with the communications device 1200 can further facilitate establishing connections with other devices. The distributed bus module 1230 may further comprise a bus node module 1232 to assist the distributed bus module 1230 with managing communications between multiple devices. In various embodiments, the bus node module 1232 may further include an object naming module 1234 to assist the bus node module 1232 in communicating with endpoint applications associated with other devices. Still further, the distributed bus module 1230 may include an endpoint module 1236 to assist the local endpoint applications 1210 in communicating with other local endpoints and/or endpoint applications accessible on other devices through an established distributed bus. In another aspect, the distributed bus module 1230 may facilitate inter-device and/or intra-device communications over multiple available transports (e.g., Bluetooth, UNIX domain-sockets, TCP/IP, Wi-Fi, etc.). Accordingly, in various embodiments, the distributed bus module 1230 and the endpoint applications 1210 may be used to establish and/or join a proximity-based distributed bus over which the communication device 1200 can communicate with other communication devices in proximity thereto using direct device-to-device (D2D) communication.

Additionally, in various embodiments, the communications device 1200 may include a user interface 1240, which may include one or more input mechanisms 1242 for generating inputs into the communications device 1200, and one or more output mechanisms 1244 for generating information for consumption by the user of the communications device 1200. For example, the input mechanisms 1242 may include a mechanism such as a key or keyboard, a mouse, a touch-screen display, a microphone, etc. Further, for example, the output mechanisms 1244 may include a display, an audio speaker, a haptic feedback mechanism, a Personal Area Network (PAN) transceiver etc. In the illustrated aspects, the output mechanisms 1244 may include an audio speaker operable to render media content in an audio form, a display operable to render media content in an image or video format and/or timed metadata in a textual or visual form, or other suitable output mechanisms. However, in various embodiments, a headless communications device 1200 may not include certain input mechanisms 1242 and/or output mechanisms 1244 because headless devices generally refer to computer systems or device that have been configured to operate without a monitor, keyboard, and/or mouse.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The methods, sequences and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an IoT device. In the alternative, the processor and the storage medium may reside as discrete components in a user terminal.

In one or more exemplary aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, DVD, floppy disk and Blu-ray disc where disks usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. The functions, steps and/or actions of the method claims in accordance with the aspects and embodiments described herein need not be performed in any particular order. Furthermore, although elements may be described above or claimed in the singular, the plural is contemplated unless limitation to the singular is explicitly stated.

What is claimed is:

1. A method to discover cloud-based services for Internet of Things (IoT) devices in an IoT network associated with a user, comprising:
discovering information about the IoT devices in the IoT network associated with the user, wherein the discovered information includes at least one or more device classes associated with the IoT devices in the IoT network;
discovering one or more cloud-based services tagged with the device classes associated with the IoT devices in the IoT network; and
offering the discovered cloud-based services in the IoT network.

2. The method recited in claim 1, wherein at least one of the discovered cloud-based services is further tagged with metadata indicating one or more required device capabilities needed for the at least one cloud-based service, one or more optional device capabilities for the at least one cloud-based service, and a specific make and model associated with an IoT device intended to consume the at least one cloud-based service.

3. The method recited in claim 1, further comprising:
filtering the discovered cloud-based services offered in the IoT network according to metadata used to tag the discovered cloud-based services and capabilities associated with the IoT devices in the IoT network.

4. The method recited in claim 1, further comprising:
invoking at least one of the discovered cloud-based services in response to a request to invoke at least one of the cloud-based services offered in the IoT network.

5. The method recited in claim 4, wherein invoking the at least one cloud-based service comprises:
connecting to at least one of the IoT devices in the IoT network to fetch any required data associated with the requested cloud-based service; and
passing the fetched data to a publisher or a provider associated with the requested cloud-based service.

6. The method recited in claim 4, wherein the user initiates the request to invoke the at least one cloud-based service offered in the IoT network.

7. The method recited in claim 4, wherein at least one of the IoT devices in the IoT network initiates the request to invoke the at least one cloud-based service.

8. The method recited in claim 7, further comprising:
requesting approval from the user prior to activating the at least one cloud-based service requested by the at least one IoT device.

9. The method recited in claim 7, further comprising:
automatically activating the at least one cloud-based service requested by the at least one IoT device in response to determining that the at least one cloud-based service is free or has a cost below a threshold.

10. The method recited in claim 1, wherein the discovered information about the IoT devices in the IoT network further includes at least one of usage information associated with the IoT devices in the IoT network, state information associated with the IoT devices in the IoT network, or a profile associated with the user.

11. The method recited in claim 10, wherein the discovered cloud-based services are further tagged with information that corresponds to at least one of the usage information associated with the IoT devices in the IoT network, the state information associated with the IoT devices in the IoT network, or the profile associated with the user.

12. The method recited in claim 1, further comprising:
enabling the IoT devices in the IoT network to collaborate with one another to determine criteria used to select the cloud-based services offered in the IoT network.

13. An Internet of Things (IoT) gateway device, comprising:
one or more processors configured to discover information about one or more IoT devices in an IoT network, wherein the discovered information includes at least one or more device classes associated with the IoT devices in the IoT network, discover one or more cloud-based services tagged with the device classes associated with the IoT devices in the IoT network, and offer the discovered cloud-based services in the IoT network; and
a memory coupled to the one or more processors.

14. The IoT gateway device recited in claim 13, wherein at least one of the discovered cloud-based services is further tagged with metadata indicating one or more required device capabilities needed for the at least one cloud-based service, one or more optional device capabilities for the at least one cloud-based service, and a specific make and model associated with an IoT device intended to consume the at least one cloud-based service.

15. The IoT gateway device recited in claim 13, further comprising:
filtering the discovered cloud-based services offered in the IoT network according to metadata used to tag the discovered cloud-based services and capabilities associated with the IoT devices in the IoT network.

16. The IoT gateway device recited in claim 13, further comprising:
invoking at least one of the discovered cloud-based services in response to a request to invoke at least one of the cloud-based services offered in the IoT network.

17. The IoT gateway device recited in claim 16, wherein invoking the at least one cloud-based service comprises:
connecting to at least one of the IoT devices in the IoT network to fetch any required data associated with the requested cloud-based service; and
passing the fetched data to a publisher or a provider associated with the requested cloud-based service.

18. The IoT gateway device recited in claim 16, wherein a user associated with the IoT network initiates the request to invoke the at least one cloud-based service offered in the IoT network.

19. The IoT gateway device recited in claim 16, wherein at least one of the IoT devices in the IoT network initiates the request to invoke the at least one cloud-based service.

20. The IoT gateway device recited in claim 19, further comprising:
requesting approval from a user associated with the IoT network prior to activating the at least one cloud-based service requested by the at least one IoT device.

21. The IoT gateway device recited in claim 19, further comprising:
automatically activating the at least one cloud-based service requested by the at least one IoT device in response to determining that the at least one cloud-based service is free or has a cost below a threshold.

22. The IoT gateway device recited in claim 13, wherein the discovered information about the IoT devices in the IoT network further includes at least one of usage information associated with the IoT devices in the IoT network, state information associated with the IoT devices in the IoT network, or a profile corresponding to a user associated with the IoT network.

23. The IoT gateway device recited in claim 22, wherein the discovered cloud-based services are further tagged with information that corresponds to at least one of the usage information associated with the IoT devices in the IoT network, the state information associated with the IoT devices in the IoT network, or the profile associated with the user.

24. The IoT gateway device recited in claim 13, further comprising:
enabling the IoT devices in the IoT network to collaborate with one another to determine criteria used to select the cloud-based services offered in the IoT network.

25. An Internet of Things (IoT) gateway device, comprising:
means for discovering information about one or more IoT devices in an IoT network, wherein the discovered information includes at least one or more device classes associated with the IoT devices in the IoT network;
means for discovering one or more cloud-based services tagged with the device classes associated with the one or more IoT devices in the IoT network; and
means for offering the discovered cloud-based services in the IoT network.

26. The IoT gateway device recited in claim 25, further comprising:
means for filtering the discovered cloud-based services offered in the IoT network according to metadata used to tag the discovered cloud-based services and capabilities associated with the IoT devices in the IoT network.

27. The IoT gateway device recited in claim 25, further comprising:
means for receiving a request to invoke at least one of the discovered cloud-based services offered in the IoT network;
means for connecting to at least one of the IoT devices in the IoT network to fetch any required data associated with the requested cloud-based service; and
means for passing the fetched data to a publisher or a provider associated with the requested cloud-based service.

28. The IoT gateway device recited in claim 27, further comprising:
means for requesting approval from a user associated with the IoT network prior to activating the at least one requested cloud-based service.

29. The IoT gateway device recited in claim 27, further comprising:
means for automatically activating the at least one requested cloud-based service in response to the requested cloud-based service being free or having a cost below a threshold.

30. A computer-readable storage medium having computer-executable instructions recorded thereon, wherein executing the computer-executable instructions on a gateway device in an Internet of Things (IoT) network causes the gateway device to:
discover information about one or more IoT devices in the IoT network, wherein the discovered information includes at least one or more device classes associated with the one or more IoT devices in the IoT network;
discover one or more cloud-based services tagged with the device classes associated with the one or more IoT devices in the IoT network; and
offer the discovered cloud-based services in the IoT network.
